(19) United States
(12) Patent Application Publication
(10) Pub. No.: US 2007/0147419 A1
(43) Pub. Date: Jun. 28, 2007

(54) Communication network system and communication apparatus

(76) Inventors: Takahiro Tsujimoto, Moriguchi-shi (JP); Shinichi Tsuchida, Ibaraki-shi (JP); Yasuyuki Shintani, Nishinomiya-shi (JP)

Correspondence Address: WENDEROTH, LIND & PONACK L.L.P., 2033 K. STREET, NW, SUITE 800, WASHINGTON, DC, 20006, US

(21) Appl. No.: 10/583,740

(22) PCT Filed: Apr. 15, 2005
(86) PCT No.: PCT/JP05/07654

§ 371 Date: Jun. 20, 2006

(30) Foreign Application Priority Data
Apr. 20, 2004 (JP) 2004-123930
Nov. 1, 2004 (JP) 2004-318569

(51) Int. Cl. H04J 3/16

(52) U.S. Cl. 370/466; 370/401

(57) ABSTRACT

The present invention provides a communication network system in which communication can be securely performed via a global network from an existing terminal apparatus to an existing device connected to a local network without needing a special gateway function in a router and without performing a special setting in the router. In the communication network system (10), a communication relay client (202) performs polling on a management center network (1) via a NAT router (204); a communication relay server (102) converts a packet transmitted from a management terminal (101); and the communication relay client (202) receives the converted packet as a response to the polling via the NAT router (204) from the side of the management center network (1). The communication relay client (202) converts the converted packet to the original packet, and transmits the original packet to a device to be managed (201).

### TECHNICAL FIELD

The present invention relates to a communication network system and a communication apparatus for performing communication via a global network.

### BACKGROUND ART

According to a conventional communication apparatus and network, a global network such as Internet and a home network as a local network are connected via Asymmetric Digital Subscriber Line (ADSL) and optical fiber circuit. For example, a private Internet Protocol (IP) address is assigned to the home network, and the private IP address and a global IP address are interconverted using a Network Address Translation (NAT) function of a router. In such network configuration as described above, it is possible to receive content provided in a World Wide Web (WEB) server connected to the global network, using a WEB browser installed on a personal computer (PC) connected to the home network. However, in such connection configuration as described above, due to the specification of the NAT function of the router, all communications must be started from the local network side.

For example, in the case where a home electrical appliance connected to the local network in the home is managed from outside the home, it is necessary to transmit a packet of Simple Network Management Protocol (SNMP) which is a protocol for network management from a management terminal on the global network side to the home electrical appliance connected to the local network.

Also, in such case as described above, the communication is performed between the device connected to the local network in the home and the device connected to the global network. Thus, the communication content needs to be protected against wiretapping and falsification.

As a network which realizes starting communication from the global network side to the local network side, Japanese Laid-Open Patent application No. 2003-318944 (p6, FIG. 1) discloses a technique for collectively managing, from one place, networks having independent realms respectively for a plurality of bases. Using such technique as described above, it is possible to manage the networks even in the case where the addresses of the apparatuses to be managed overlap between the bases (for example, refer to the Japanese Laid-Open Patent application No. 2003-318944 (p6, FIG. 1)). FIG. 1 shows a conventional communication apparatus and network as disclosed in the Japanese Laid-Open Patent application No. 2003-318944 (p6, FIG. 1).

In FIG. 1, the capsule processing unit 52 of the network management system 50 encapsulates an SNMP packet generated in an SNMP processing unit 51 using a tunneling protocol, and then transmits the encapsulated SNMP packet to the base gateways 61 and 71 via Internet. The base gateways 61 and 71 break encapsulation, and extract the original SNMP packet. Thereby, the SNMP packet can be transmitted to a communication apparatus 63 of a base internal network 62. Thus, the SNMP packet can be transparently transmitted from the global network side to the local network side, and the apparatus to be managed can be managed.

### DISCLOSURE OF INVENTION

According to the conventional configuration, it is assumed that the base gateway comply with the specified tunneling protocol. In the case where the conventional configuration is applied to collectively managing the home network from the side of the global network, a home NAT router provides a base gateway function.

However, most NAT routers do not comply with the tunneling protocol. Thus, there is a problem that application of the conventional configuration cannot be necessarily realized. Also, even in the case where a NAT router complies with the tunneling protocol, setting operations related to the tunneling protocol must be performed by a user himself. And, there is a problem that the user himself is forced to learn the advanced technique related to network setting which is necessary for the setting operations.

An object of the present invention, in view of the above mentioned problems, is to provide a communication network system and a communication apparatus by which communication can be securely performed via a global network from an existing terminal apparatus to an existing device connected to a local network without needing a special gateway function in a router and without performing a special setting in the router, the network connecting the global network with the local network via the router.

In order to solve the conventional problems, the communication network system according to the present invention includes a first system and a second system which are connected via a global network, wherein said first system includes: a terminal apparatus operable to communicate with a device; and a first communication relay apparatus, which is connected to said terminal apparatus, operable to relay communication between said terminal apparatus and said second system via said global network, said second system includes: a router apparatus operable to connect said global network with a local network; the device which is connected to said local network and is communicated with said terminal apparatus; and a second communication relay apparatus, which is connected to said local network, operable to relay communication between said device and said first system via said router apparatus and said global network, said first communication relay apparatus has: a first communication unit operable to communicate with said terminal apparatus using a first protocol; a second communication unit operable to communicate with said second system using a second protocol via said global network; and a first conversion unit operable to convert packet data into second protocol packet data as a converted packet, the packet data being acquired from said terminal apparatus by said first communication unit, and to transmit the converted packet to said second communication unit, and also operable to convert packet data into first protocol packet data, the packet data being acquired from said second system by said second communication unit, and to transmit the first protocol packet data to said first communication unit, said second communication relay apparatus has: a third communication unit operable to communicate with the device using the first protocol via the local network; a fourth communication unit operable to communicate with said first system using the second protocol; and a second conversion unit operable to convert packet data into second protocol packet data, the packet data being acquired from the device by said third communication unit, and to transmit the second protocol packet data to said fourth communication unit, and also operable to convert the converted packet into first protocol packet data, the converted packet being acquired from said first system by said fourth communication unit, and to transmit the first protocol packet data to said first communication unit, and said second communication relay apparatus is operable to transmit a predetermined packet to said first system via said router apparatus, and said first system is operable to transmit the converted packet to an address of a transmission source of the predetermined packet.

Thus, in the communication network system including the first system and the second system connected via the global network, the second communication relay apparatus transmits the predetermined packet to the first system; the first system transmits the packet data to the transmission source of the packet; and the second communication relay apparatus can receive the packet data from the first system.

As described above, the second communication relay apparatus receives the packet data as the response to the transmitted packet data from the first system. In other words, the packet data can be transmitted from the side of the first system via the global network over the router apparatus to the second communication relay apparatus.

Also, after the packet data is transmitted using the first protocol from the terminal apparatus connected to the first system, the first protocol packet data is converted into the second protocol packet data by the first communication relay apparatus, and the second protocol packet data is transmitted via the global network to the second system. The transmitted second protocol packet data is received by the second communication relay apparatus via the router apparatus connected to the second system. And, the second protocol packet data is converted into the first protocol packet data, and then transmitted to the device.

In other words, the packet data transmitted from the terminal apparatus connected to the first system can be transparently transmitted to the device connected to the second system.

As a result, the communication can be securely performed via the global network from the existing terminal apparatus to the existing device connected to the local network without needing a special gateway function in the router and without performing a special setting in the router, the network connecting the global network with the local network via the router.

According to the communication apparatus and the communication network system of the present invention, it is possible to provide, in the network where the global network and the local network are connected via the router, the communication network system and the communication apparatus by which the communication can be securely performed via the global network from the existing terminal apparatus to the existing device connected to the local network without needing a special gateway function in a router and without performing a special setting in the router.

### FURTHER INFORMATION ABOUT TECHNICAL BACKGROUND TO THIS APPLICATION

The disclosure of Japanese Patent Applications No. 2004-123930 filed on Apr. 20, 2004 and No. 2004-318569 filed on Nov. 1, 2004 including specification, drawings and claims is incorporated herein by reference in its entirety.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing a whole configuration of a conventional communication network;

FIG. 2 is a diagram showing a hardware configuration of a communication network system according to an embodiment of the present invention;

FIG. 3 is a diagram showing an overview of an application example of a communication network system;

FIG. 4 is a sequence diagram showing operations of a NAT router;

FIG. 5 is a network configuration diagram showing a communication relation between a management terminal and a device to be managed;

FIG. 6 is a diagram showing an example of data configuration of an SNMP packet;

FIG. 7 is a functional block diagram showing a functional configuration of devices connected to a management center network;

FIG. 8 is a functional block diagram showing a functional configuration of devices connected to a local network;

FIG. 9 is a diagram showing an overview of information flow between respective devices included in a communication network system;

FIG. 10 is a sequence diagram showing operations performed by a communication relay client in acquiring a device ID;

FIG. 11 is a sequence diagram showing operations performed by a communication relay client in polling;

FIG. 12 is a sequence diagram showing operations of SNMP packet conversion performed by a communication relay server and trigger packet transmission performed by a trigger server;

FIG. 13 is a sequence diagram showing operations of converted packet acquisition and an SNMP request transmission performed by a communication relay client;

FIG. 14 is a diagram showing an example of data configuration of a converted packet communicated between a communication relay client and a communication relay server;

FIG. 15 is a sequence diagram showing operations in which an SNMP agent transmits an SNMP response to an SNMP manager;

FIG. 16 is a functional block diagram showing a functional structure of another device to be managed;

FIG. 17 is a sequence diagram showing a case where a communication relay client inquires about a request before queuing completion of an SNMP message;

FIG. 18 is a sequence diagram showing an example in which a communication relay server controls a communication relay client's timing of making an inquiry about a request; and

FIGS. 19A, 19B and 19C are diagrams showing respective communication patterns of SNMP requests and SNMP responses.

FIG. 20 is a functional block diagram showing an example of a functional configuration of a device to be managed which includes a communication relay client function and a function of communicating with a sensor;

FIG. 21 is a diagram showing an example of a configuration of sensor data transmitted from a sensor;

FIG. 22 is a sequence diagram showing operations performed by each device when an SNMP agent transmits a value of temperature measured by a sensor to an SNMP manager;

FIG. 23 is a schematic diagram showing the way that N (N is a positive integer) sensors directly communicate with a sensor communication unit wirelessly;

FIG. 24 is a schematic diagram showing an ad-hoc network made up of a plurality of sensors;

FIG. 25 is a diagram showing an example of a configuration of sensor data including position information;

FIG. 26 is a functional block diagram showing an example of a functional configuration of a device to be managed including a communication relay client function and a function of communicating with an actuator;

FIG. 27 is a sequence diagram showing operations performed by each device when an SNMP manager requests an actuator to change a preset temperature;

FIG. 28 is a schematic diagram showing the way that N (N is a positive integer) actuators communicate with an actuator wirelessly communication unit; and

FIG. 29 is a schematic diagram showing an ad-hoc network made up of a plurality of actuators.

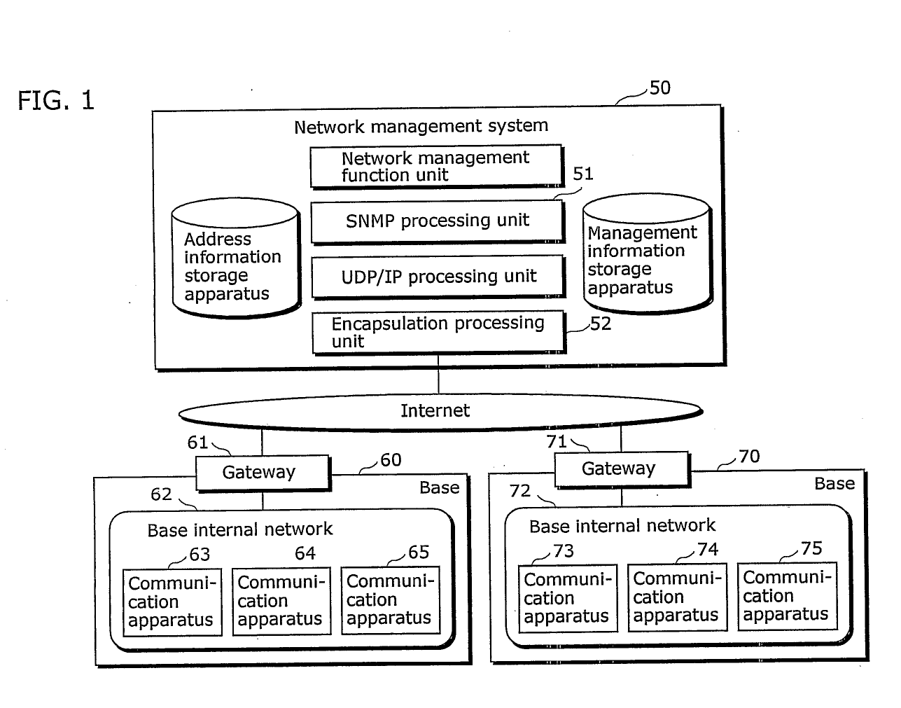

### BEST MODE FOR CARRYING OUT THE INVENTION

A whole configuration of a communication network system according to the present invention will be described referring to the drawings.

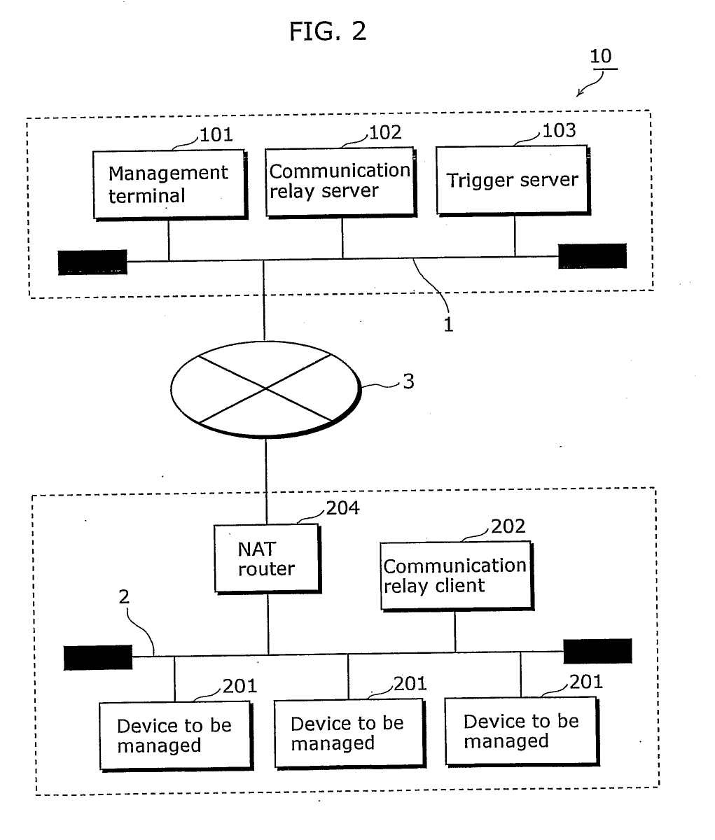

FIG. 2 is a diagram showing a hardware configuration of a communication network system 10 according to an embodiment of the present invention. The communication network system 10 is a system for managing devices from a management center network 1 via a global network 3, the devices being connected to a local network 2.

As shown in FIG. 2, the communication network system 10 includes: the global network 3 which can be publicly used such as Internet; a local network 2 formed in a local environment such as a home; and a management center network 1 for managing the devices and the like connected to the local network 2.

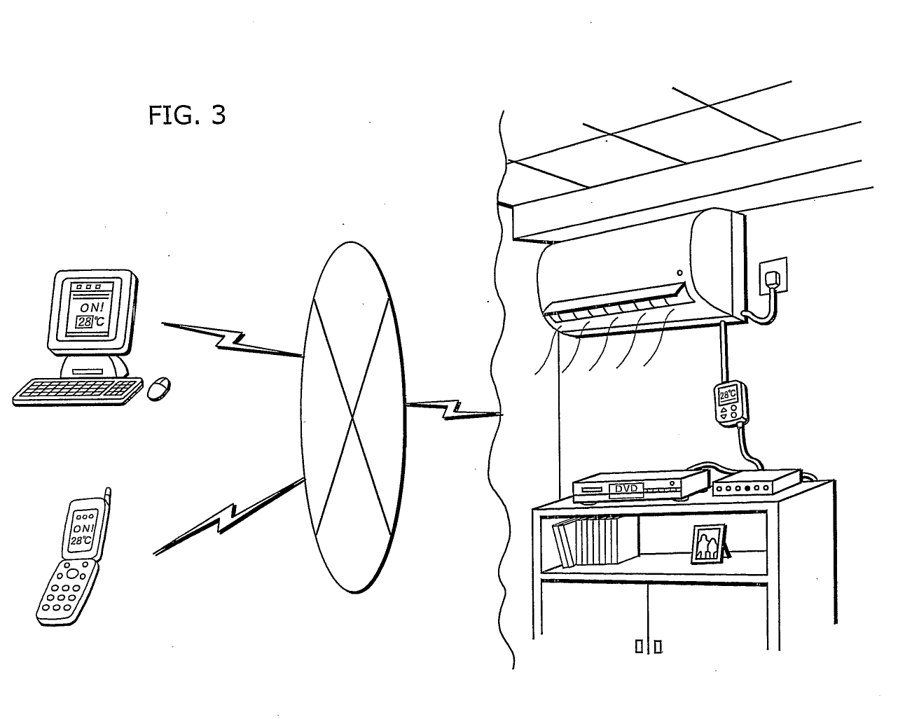

For example, as shown in FIG. 3, the communication network system 10 can be applied to a network system in which home electrical appliances such as an air conditioner are remote operated by operating a terminal device from outside the home, the home electrical appliances being connected to a home local network.

The management center network 1 is an example of the first system included in the communication network system according to the present invention. The management center network 1 includes: a management terminal 101; a communication relay server 102; and a trigger server 103. The management terminal 101 is an example of a terminal apparatus included in the communication network system according to the present invention. And, the communication relay server 102 is an example of the first communication relay apparatus according to the present invention.

The management terminal 101 is a terminal device operated by an operator, and performs management such as monitoring and setting the devices connected to the local network 2. The communication relay server 102 is a communication device which relays communication between the management terminal 101 and the devices connected to the local network 2. The trigger server 103 is a communication device which stores address information of the devices connected to the local network 2 and notifies the devices connected to the local network 2 of communication start from the management center network 1.

The local network 2 is an example of the second system included in the communication network system according to the present invention. And, the local network 2 includes: devices to be managed 201; a communication relay client 202; and a NAT router 204. The device to be managed 201 is an example of a device included in the communication network system according to the present invention. And, the communication relay client 202 is an example of the second communication relay apparatus according to the present invention.

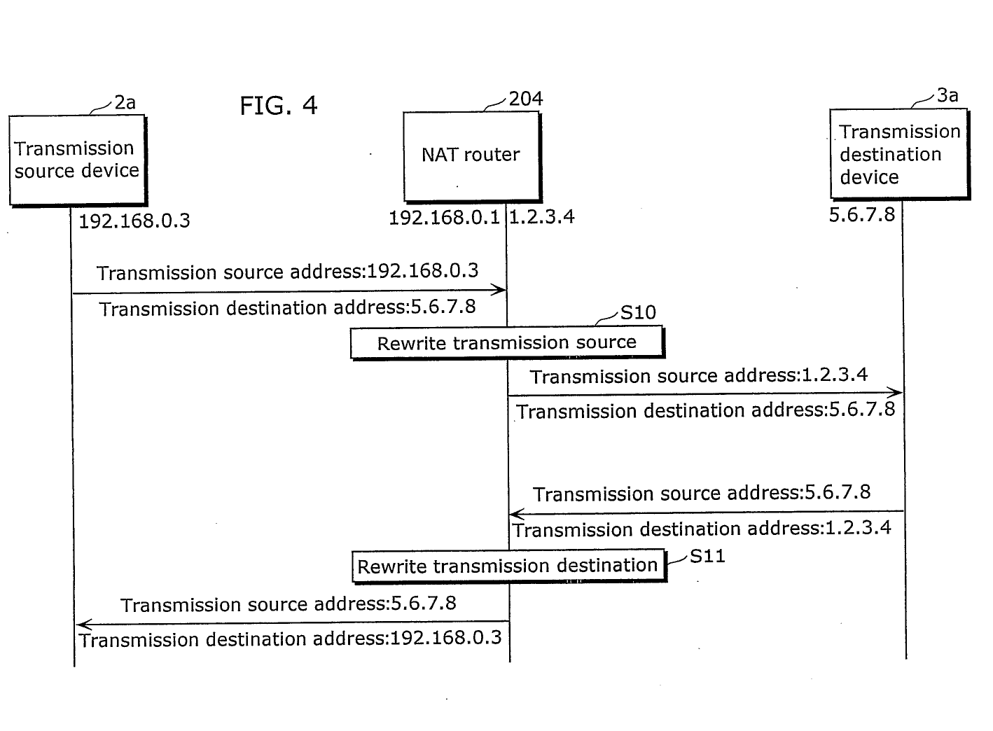

The device to be managed 201 is a device to be managed by the management terminal 101 connected to the management center network 1. And, the device to be managed 201 has a device ID which is an identifier for uniquely identifying the device. The communication relay client 202 is a communication device which relays communication between the device to be managed 201 and the device connected to the management center network 1. The NAT router 204 is a device which relays communication between the local network 2 and the global network 3. The operations of relaying the above mentioned communication performed by the NAT router 204 will be described later using FIG. 4.

Addresses for uniquely distinguishing each device are assigned to respective communication devices connected to the global network 3 and the management center network 1 included in the communication network system 10.

For example, an IP address is used as such realm as described above, and a different IP address is assigned to each communication device.

The management center network 1 is connected to the global network 3 via a gateway which is not shown in the drawing, the gate way determining a communication path between the management center network 1 and the global network 3.

IP addresses for uniquely distinguishing each device is assigned to respective communication devices connected to the local network 2 included in the communication network system 10. Here, as long as the respective communication devices connected to the local network 2 can be uniquely distinguished within the local network 2, a communication device connected to the local network 2 may have an overlapping IP address with one of the devices connected to the global network. Such IP address which only locally guarantees uniqueness is called a local network address. On the other hand, the IP address assigned to each communication device connected to the global network 3 and the management center network 1 is called a global network address, and distinguished from the local network address.

As described above, the global network addresses are assigned to all of the devices connected to the global network 3 and the management center network 1. In other words, the management center network 1 is a part of the global network 3. Thus, the devices connected to the management center network 1 are the devices connected to the global network 3 in communicating with the devices connected to the local network.

The local network 2 is connected to the global network 3 via the NAT router 204 having a function of interconverting the local network addresses with the global network addresses. Due to such connection as described above, the communication devices connected to the local network 2 can communicate with the devices in an IP layer, by the operations performed by the NAT router 204 described as follows, the devices being connected to the global network 3 and the management center network 1.

FIG. 4 is a sequence diagram showing the operations performed by the NAT router 204. The operations performed by the NAT router 204 will be described using FIG. 4. Here, in order to describe the operations performed by the NAT router 204, the following environment is assumed: a transmission source device 2a is connected to the local network side of the NAT router 204, and a transmission destination device 3a is connected to the global network side. In the NAT router 204, the global network address is assigned to the global network side, and the local network address is assigned to the local network side.

Here, as an example, 1.2.3.4 is assigned as the global network address, and 192.168.0.1 is assigned to the local network address. As an example, 192.168.0.3 is assigned to the transmission source device 2a as the local network address, and 5.6.7.8 is assigned to the transmission destination device 3a as the global network address. Needless to say, concrete numbers for these addresses are not limited to the above mentioned examples.

When the transmission source device 2a transmits a packet to the transmission destination device 3a, the transmission source address of the packet is 192.168.0.3, and the transmission destination address is 5.6.7.8.

When the packet is transmitted to the global network via the NAT router 204, the NAT router 204 rewrites the transmission source address of the packet from 192.168.0.3 which is the local network address of the transmission source device 2a to 1.2.3.4 which is the global network address of the NAT router 204 (S10). When the packet reaches the transmission destination device 3a, the transmission destination device 3a regards that the packet has been transmitted from the NAT router 204. Thus, the transmission destination device 3a generates a response packet according to need, and returns the response packet to the NAT router 204.

Here, the transmission source address of the response packet is 5.6.7.8 which is the global address of the transmission destination device 3a, and the transmission destination address of the response packet is 1.2.3.4 which is the global address of the NAT router 204. When the NAT router 204 receives the response packet, the NAT router 204 rewrites the transmission destination address to 192.168.0.3 which is the local network address of the transmission source device 2a (S11), and transmits the response packet to the transmission source device 2a. Thus, the communication between the transmission source device 2a and the transmission destination device 3a is established.

In order to rewrite the transmission destination address of the response packet to the address of the transmission source device 2a, the NAT router 204 includes an address conversion table in which the local network addresses and the global network addresses are associated with each other.

In other words, when the packet transmitted from the transmission source device 2a to the transmission destination device 3a passes the NAT router 204, the local network address of the transmission source device 2a and the global network address of the transmission destination device 3a are associated with each other and stored in the address conversion table. When the response to the transmitted packet is returned, the corresponding association are searched in reference to the address conversion table, and the local network address of the device to which the response to the transmitted packet should be transmitted, that is the local network address of the transmission source device 2a is derived.

The NAT router 204 rewrites the transmission destination address of the response packet from the global network address of the NAT router 204 to the derived local network address of the transmission source device 2a.

As a protocol for a transport layer, in the case where Transmission Control Protocol (TCP) is used, address associations between the transmission sources and the transmission destinations stored in the address conversion table are kept until the connection is severed. In the case where User Datagram Protocol (UDP) is used, the address associations stored in the address conversion table are kept for a predetermined period. After the predetermined period elapses, the address associations stored in the address conversion table are deleted from the NAT router 204.

As described above, in the communication from the transmission destination device 3a to the transmission source device 2a, the address conversion is performed based on the address conversion table included in the NAT router 204. Therefore, in the case where the association between the local network address of the transmission source device 2a and the global network address of the transmission destination device 3a is not stored in the NAT router 204, the communication cannot be performed. In other words, as a characteristic of a communication performed over the NAT router 204, it is easy to start a communication from the side of the local network 2 to the side of the global network 3 over the NAT router 204, but it is difficult to start a communication from the side of the global network 3 to the side of the local network 2 over the NAT router 204.

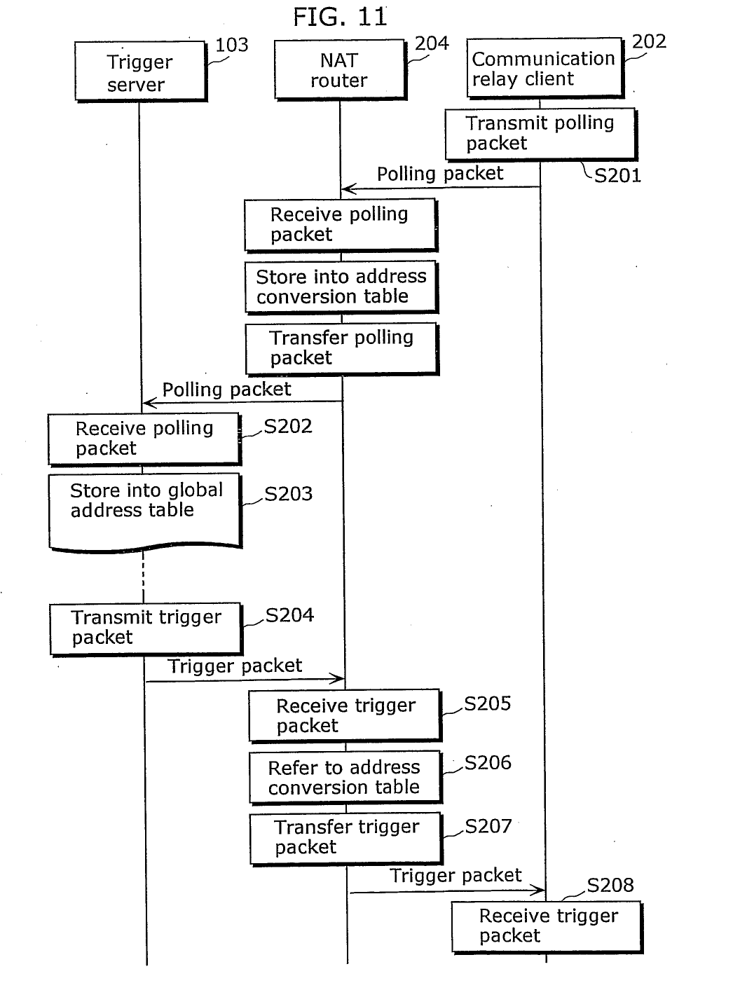

However, in the communication network system 10 which is the embodiment of the present invention, it is possible to start a communication from the side of the global network 3 to the side of the local network 2 over the NAT router 204, by the operations performed by the trigger server 103 and the like which will be described later using FIG. 11.

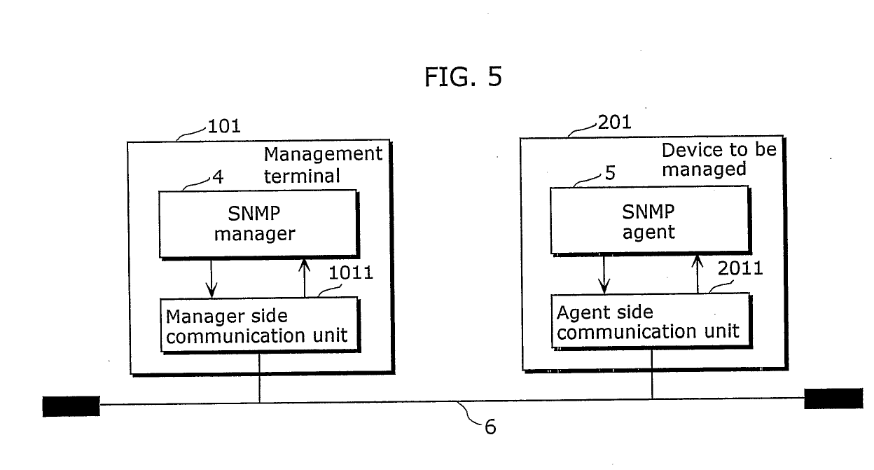

FIG. 5 is a diagram showing a network configuration in which a management terminal 101 and a device to be managed 201 are connected to each other.

The management terminal 101 communicates an SNMP packet with the device to be managed 201, thus manages the device to be managed 201. The overview of the communication performed between the management terminal 101 and the device to be managed 201 will be described using FIG. 5.

Here, in order to describe the overview of the communication between the management terminal 101 and the device to be managed 201, the following case is assumed: the management terminal 101 and the device to be managed 201 are directly connected to each other via a network 6, as shown in FIG. 5 which is different from the configuration of FIG. 2. The respective devices can directly recognize each other by their addresses.

The management terminal 101 is a terminal device which is operated by an operator and performs management such as monitoring and setting of the device to be managed 201. And the management terminal 101 includes: an SNMP manager 4 and a manager side communication unit 1011.

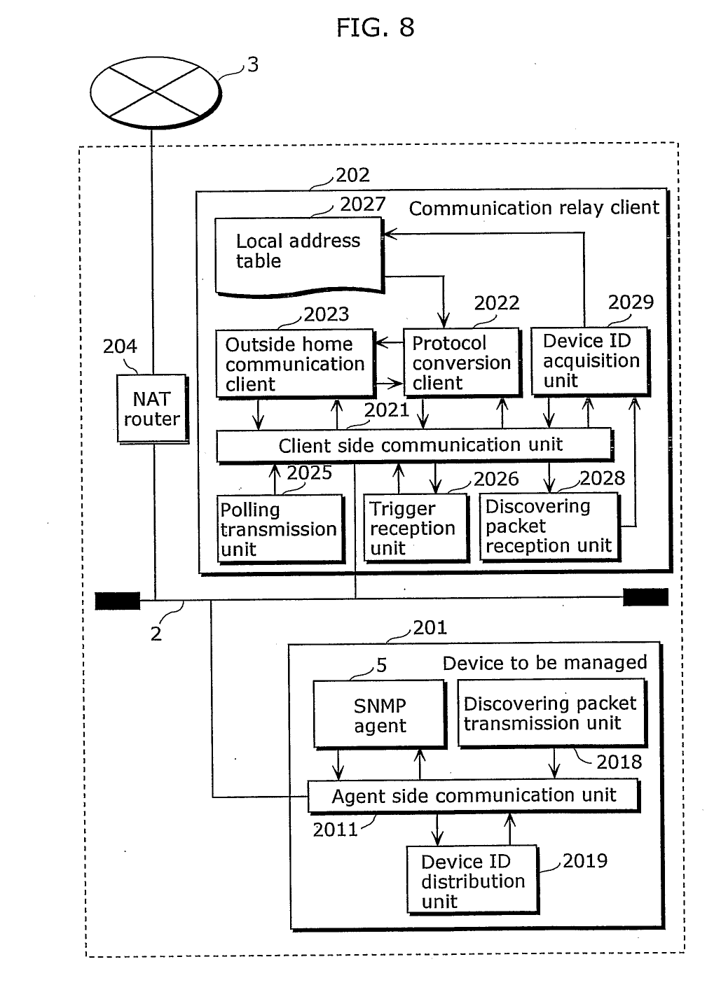

The device to be managed 201 is a device to be managed by the management terminal 101. And, the device to be managed 201 includes an SNMP agent 5 and an agent side communication unit 2011. Here, the device to be managed 201 includes other processing units which are not shown in FIG. 5, but these processing units are omitted in FIG. 5 in order to simplify the description. The functional configuration of the device to be managed 201 will be described later using FIG. 8.

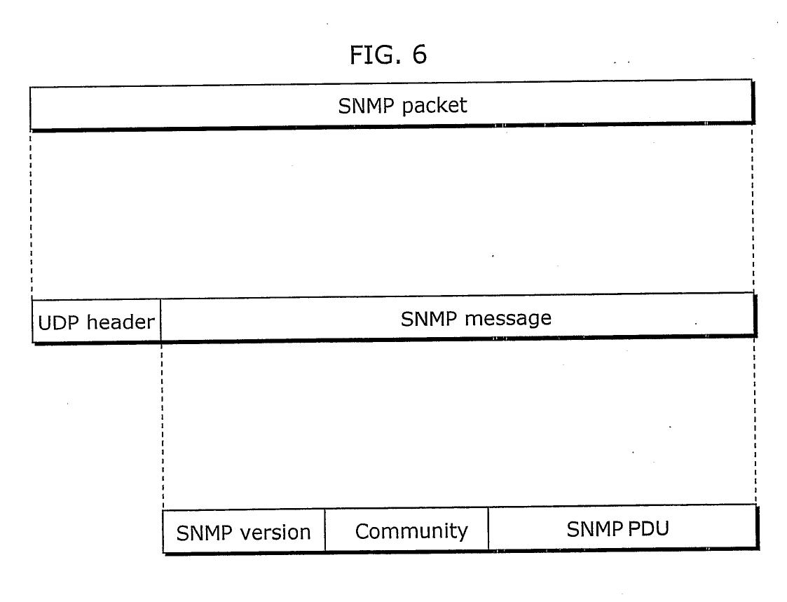

The communication protocol used between the management terminal 101 and the device to be managed 201 is SNMP. SNMP is a protocol used for managing the network device, and information is communicated using the form of an SNMP packet as shown in FIG. 6.

FIG. 6 is a diagram showing an example of a data configuration of an SNMP packet. As shown in FIG. 6, the SNMP packet includes an SNMP message and a UDP header. The SNMP message is made up of: an SNMP version which stores an SNMP protocol version; a community which stores community names for a device to be managed to authenticate a manager; and an SNMP PDU which stores actual request details and response details.

The SNMP manager 4 included in the management terminal 101 generates an SNMP message (hereinafter referred to as “SNMP request” as well) which includes request details such as acquiring the state of the device to be managed 201. And, the SNMP manager 4 transmits the SNMP message in the form of an SNMP packet to the SNMP agent 5 via the manager side communication unit 1011, the network 6, and the agent side communication unit 2011.

The SNMP agent 5 monitors the state of the device to be managed 201, and performs processing such as acquiring the value of the state variable and setting the value of the state variable, according to the SNMP message included in the received SNMP packet. Moreover, the SNMP agent 5 returns, to the SNMP manager 4, the SNMP message (hereinafter referred to as “SNMP response” as well) which includes response details such as the processing results in the form of the SNMP packet.

In other words, in the server/client model, the SNMP agent 5 included in the device to be managed 201 is the server, and the SNMP manager 4 included in the management terminal 101 is the client.

As described above, the management terminal 101 and the device to be managed 201 communicate the SNMP packet, thus the device to be managed 201 can be managed from the management terminal 101. For example, a preset temperature of an air conditioner can be changed from a terminal apparatus including the SNMP manager 4 via a network, the air conditioner being included in the SNMP agent 5.

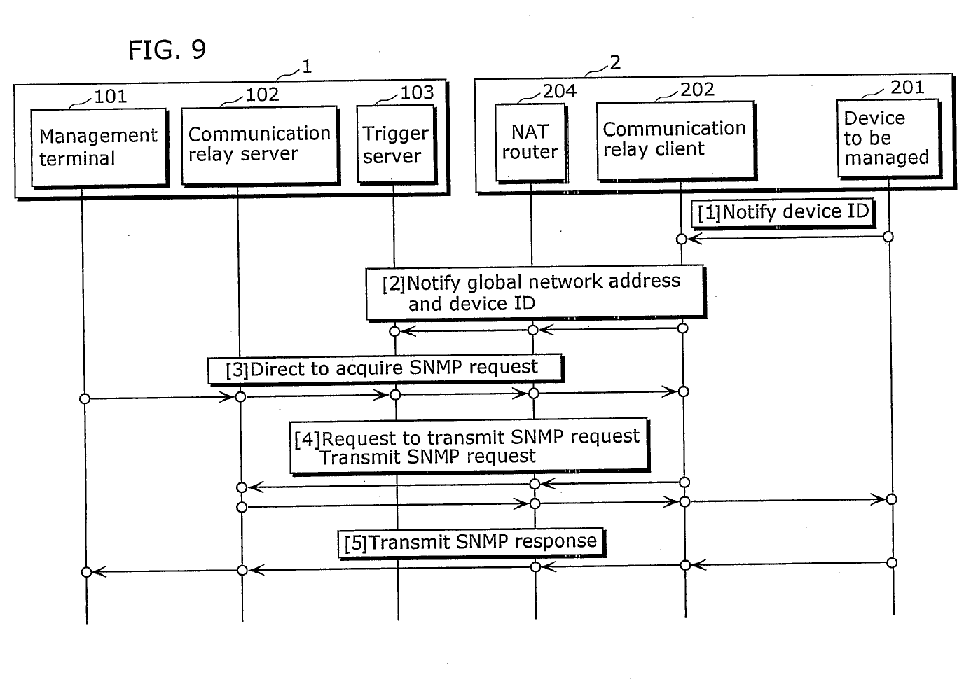

In the communication network system 10 as shown in FIG. 2, the management terminal 101 and the device to be managed 201 so not directly communicate with each other. However, by the packet conversion and the like performed by the communication relay server 102 and the communication relay client 202, the SNMP packet can be communicated transparently and securely. The operations performed by each device included in the communication network system 10 in time of the SNMP packet communication will be described later using FIGS. 9 to 15.

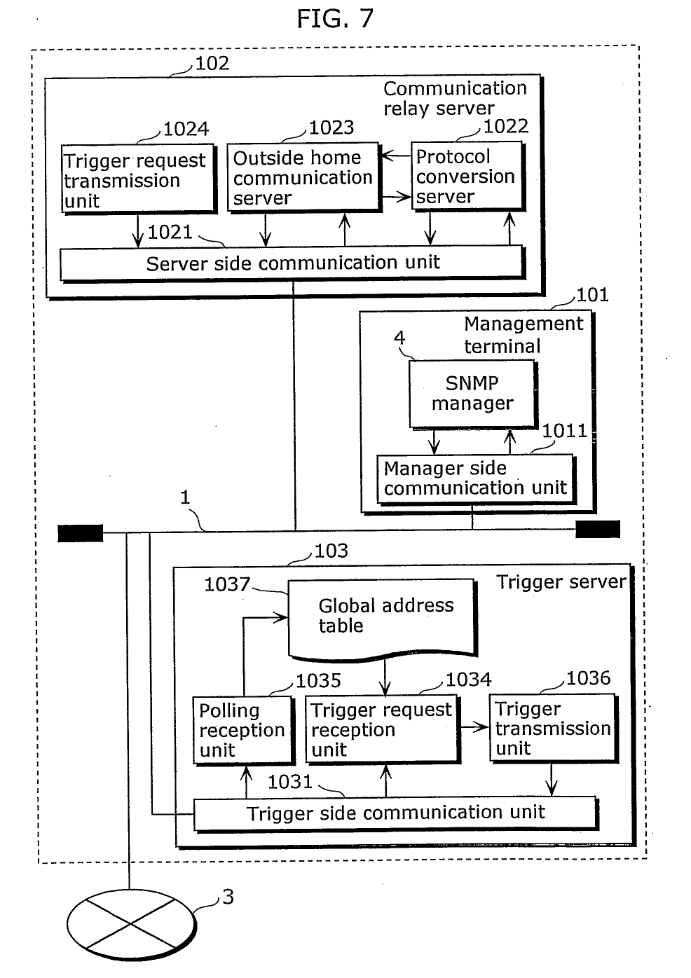

Next, the functional configuration of each device included in the communication network system 10 will be described using FIGS. 7 and 8.

FIG. 7 is a functional block diagram showing a functional configuration of each device connected to the management center network 1. As shown in FIG. 7, the management terminal 101, the communication relay server 102 and the trigger server 103 are connected to the management center network 1.

As described using FIG. 5, the management terminal 101 is a, terminal device which manages and sets the device to be managed 201, and includes the SNMP manager 4 and the manager side communication unit 1011.

The communication relay server 102 is a device which provides a server function to the SNMP manager 4 included in the management terminal 101, and relays a packet to the communication relay client 202 connected to the local network 2.

The communication relay server 102 includes: a server side communication unit 1021 which performs communication; a protocol conversion server 1022 which provides a server function to the SNMP manager 4 and acquires and processes the SNMP packet; an outside home communication server 1023 which communicates packets with the protocol conversion server 1022, and communicates with the communication relay client 202 connected to the local network 2; and a trigger request transmission unit 1024 which transmits a trigger request packet that requests trigger transmission to the trigger server.

The protocol conversion server 1022 realizes a communication function held by the first communication unit included in the first communication relay apparatus according to the present invention. And, the outside home communication server 1023 realizes a communication function held by the second communication unit included in the first communication relay apparatus according to the present invention. Also, the protocol conversion server 1022 and the outside home communication server 1023 realize a protocol conversion function held by the first conversion unit included in the first communication relay apparatus according to the present invention.

The trigger server 103 is a device which stores address information of the devices to be managed 201 connected to the local network 2, and notifies, to the communication relay client 202, the timing at which the communication relay client 202 acquires a packet including an SNMP request from the communication relay server 102.

The trigger server 103 includes: a trigger side communication unit 1031 which performs communication; a trigger request reception unit 1034 which receives a trigger request packet transmitted from the trigger request transmission unit 1024 included in the communication relay server 102; a polling reception unit 1035 which receives a polling packet transmitted from the communication relay client 202; a global address table 1037 which associates a device ID with a global network address and store the association, the device ID belonging to the device to be managed 201, and the global network address belonging to the NAT router 204, the device ID and the global network address being acquired from the polling packet; and a trigger transmission unit 1036 which transmits a trigger packet to the communication relay client 202.

The trigger server 103 refers to the global address table 1037, and identifies a global network address of the NAT router 204 based on the device ID of the device to be managed 201.

FIG. 8 is a functional block diagram showing a functional configuration of each device connected to the local network 2. As shown in FIG. 8, the NAT router 204, the device to be managed 201 and the communication relay client 202 are connected to the local network 2.

As described using FIG. 4, the NAT router 204 is a device which relays communication between the local network 2 and the global network 3 by the function of interconverting the local network addresses and the global network addresses.

The device to be managed 201 is a device to be managed by the management terminal 101. And, the device to be managed 201 includes: the SNMP agent 5 and the agent side communication unit 2011 as described using FIG. 5; a discovering packet transmission unit 2018 which transmits a relay client discovering packet for discovering the communication relay client 202; and a device ID distribution unit 2019 which transmits a device ID to the communication relay client 202, the device ID being an identifier previously assigned for uniquely identifying a device which includes the SNMP agent 5.

The communication relay client 202 is a device which provides a client function to the SNMP agent 5 included in the device to be managed 201, and relays, to the device to be managed 201, a packet transmitted from the communication relay server 102.

The communication relay client 202 includes: a client side communication unit 2021 which performs communication; a protocol conversion client 2022 which (i) provides a client function to the SNMP agent 5, (ii) converts the packet acquired from the communication relay server 102 into the SNMP packet and (iii) transmits the SNMP packet to the SNMP agent 5; an outside home communication client 2023 which communicates with the communication relay server 102; a polling transmission unit 2025 which (i) transmits a polling packet to the trigger server 103, the polling packet notifying the device ID of the device to be managed 201 and the global network address of the NAT router 204, and (ii) causes the NAT router 204 to store the address conversion table; a trigger reception unit 2026 which receives the trigger packet transmitted from the trigger server 103; a local address table 2027 used for associating the device ID of the device to be managed 201 and the local network address and specifying the device to be managed 201 based on the device ID; a discovering packet reception unit 2028 which receives a communication relay client discovering packet; and a device ID acquisition unit 2029 which receives a device ID.

The protocol conversion client 2022 realizes the communication function held by the third communication unit included in the second communication relay apparatus according to, the present invention. And, the outside home communication client 2023 realizes a communication function held by the fourth communication unit included in the second communication relay apparatus according to the present invention. In addition, the protocol conversion client 2022 and the outside home communication client 2023 realize a protocol conversion function held by the second conversion unit included in the second communication apparatus according to the present invention.

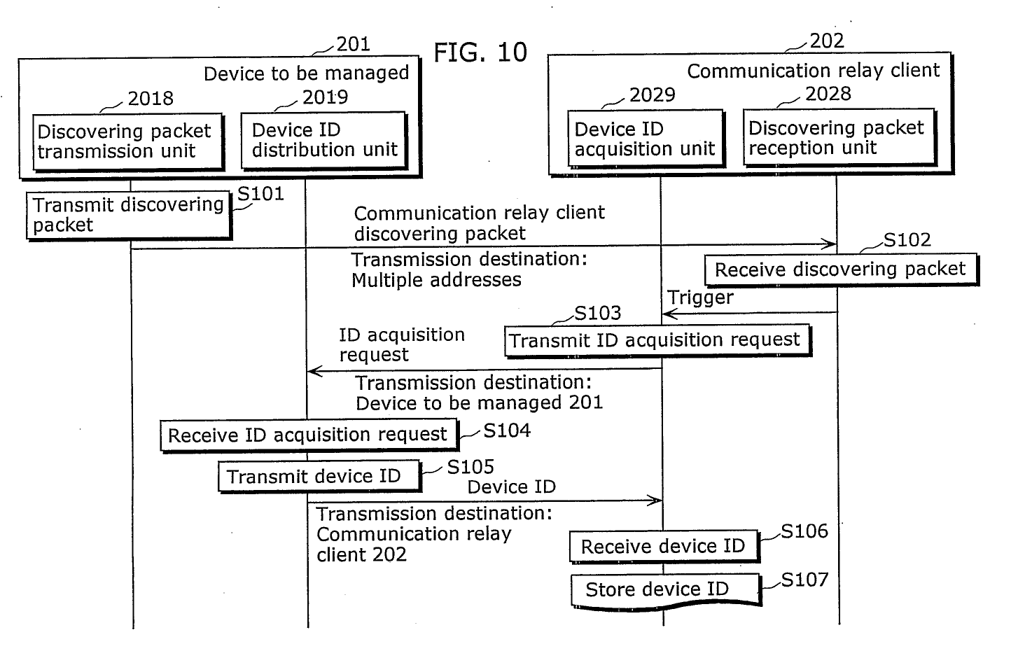

Next, the operations performed by each device included in the communication network system 10 configured as described above according to the present embodiment will be described briefly using FIG. 9 and concretely using FIGS. 10 to 15.

FIG. 9 is a diagram showing an overview of information flow between the respective devices included in the communication network system 10 when the management terminal 101 manages the device to be managed 201, that is, when the SNMP messages such as the SNMP request and the SNMP response are communicated between the management terminal 101 and the device to be managed 201.

In the case where a communication is performed between the local network 2 and the management center network 1, the information is always communicated via the NAT router 204. Here, as described using FIG. 4, the global network addresses are interconverted with the local network addresses in the NAT router 204. However, in order to simplify the description, the operations performed by the NAT router 204 are omitted in the description using FIG. 9. Also, the SNMP message is added with the UDP header, and communicated in the form of the SNMP packet.

[1] The device to be managed 201 notifies the communication relay client 202 of its own device ID. The concrete operations will be described using FIG. 10.

[2] The communication relay client 202 transmits the polling packet to the trigger server 103, the polling packet notifying the device ID of the device to be managed 201 and the global network address of the NAT router 204.

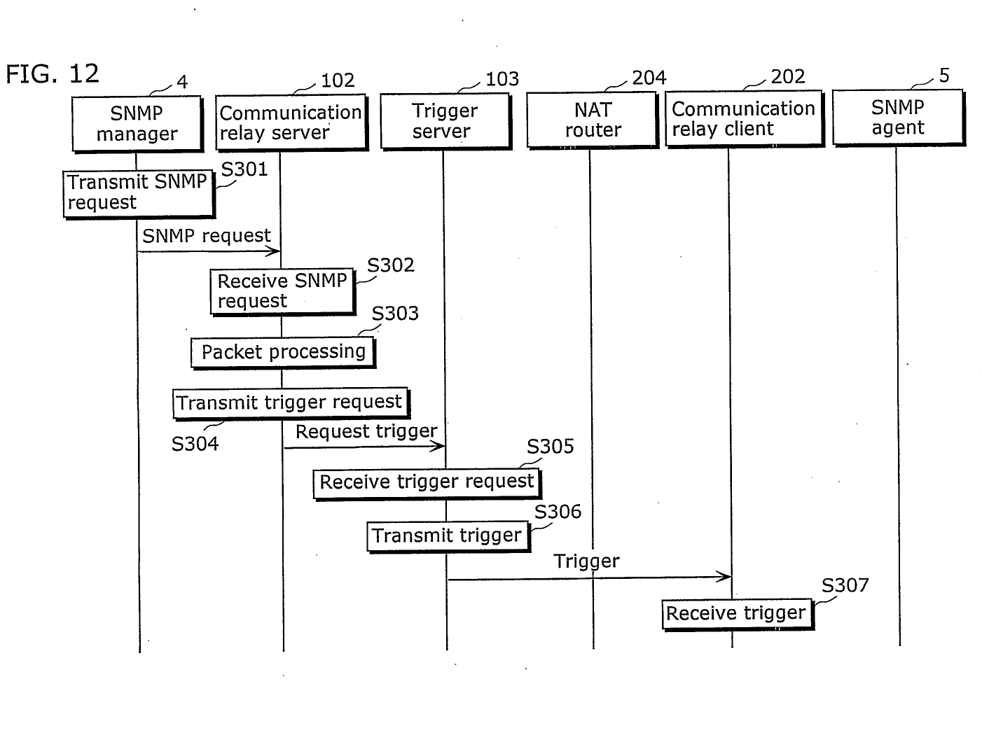

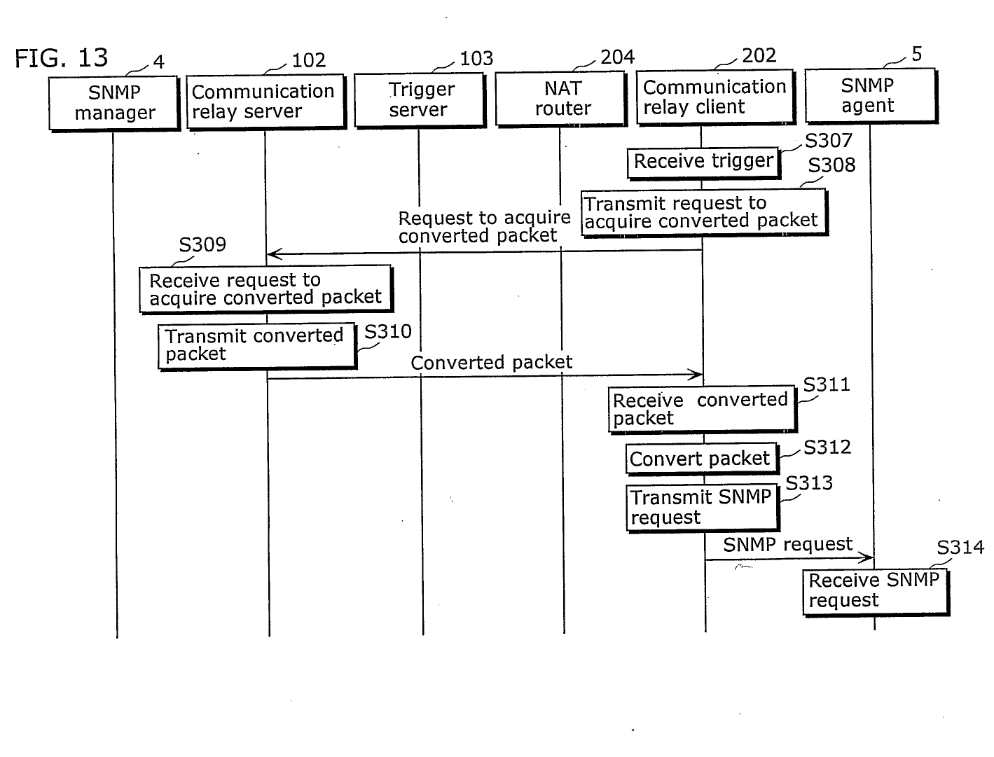

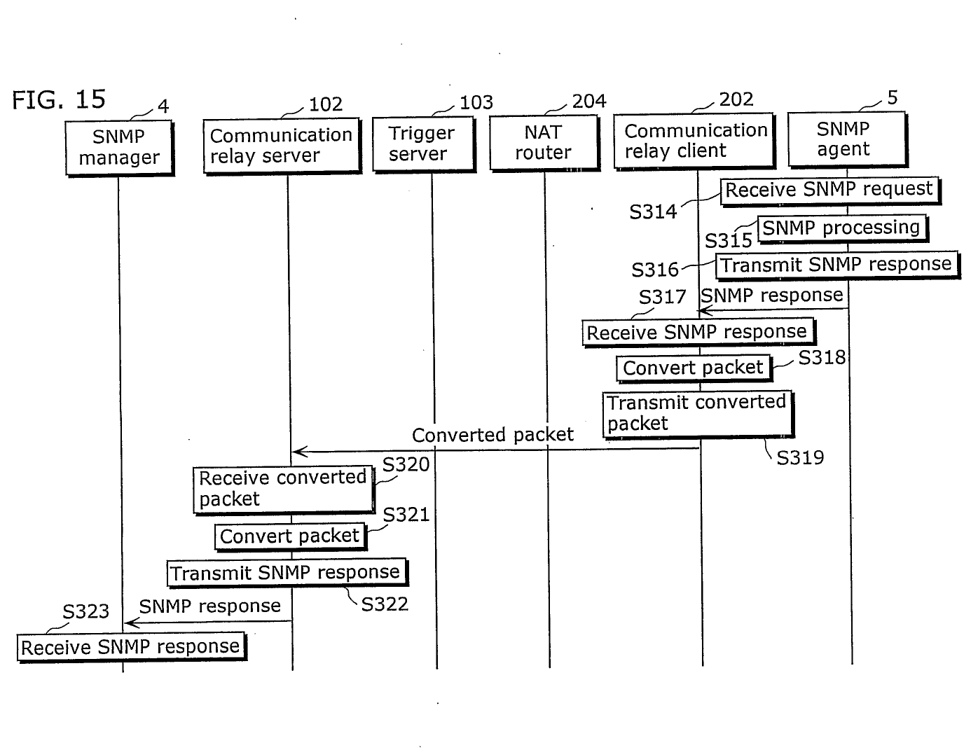

According to the above mentioned polling packet, the trigger server 103 acknowledges the device ID of the device to be managed 201 and the global network address of the local network 2 to which the device to be managed 201 belongs. And, the trigger server 103 associates the device ID with the global network address, and stores the associated information. Based on the stored information, the trigger server 103 can transmit information, over the NAT router 204, to the device connected to the local network 2. Using the trigger server 103, the communication with the device to be managed 201 is performed, the communication being started from the management terminal 101. The concrete operations will be described later using FIG. 11.

[3] The SNMP request is transmitted in the form of the SNMP packet from the management terminal 101 to the communication relay server 102. The communication relay server 102 requests the trigger server 103 to direct the SNMP request acquisition to the communication relay client 202, the communication relay server 102 having received the SNMP packet from the management terminal 101. Then, the trigger server 103 transmits the trigger packet to the communication relay client 202, the trigger packet being a direction to acquire the SNMP request from the communication relay server 102. The concrete operations will be described later using FIG. 12.

[4] The communication relay client 202 requests the communication relay server 102 to acquire the converted packet including the SNMP request, the communication relay client 202 having received the trigger packet. Then, the communication relay server 102 generates a converted packet, and transmits the converted packet to the communication relay client 202, the converted packet being generated by encapsulating the SNMP message included in the SNMP packet using Hyper Text Transfer Protocol (HTTP). The communication relay client 202 extracts the SNMP message from the received converted packet, and transmits the SNMP message in the form of the SNMP packet to the device to be managed 201. The concrete operations will be described later using FIG. 13.

[5] The device to be managed 201 performs SNMP processing according to the SNMP request included in the received SNMP packet. And, the device to be managed 201 transmits an SNMP response which is the response to the SNMP request in the form of the SNMP packet to the communication relay client 202. The communication relay client 202 generates a converted packet and transmits the converted packet to the communication relay server 102, the converted packet being generated by encapsulating the SNMP response included in the SNMP packet using HTTP. The communication relay server 102 extracts the SNMP response from the received converted packet, and transmits the extracted SNMP response in the form of the SNMP packet to the management terminal 101. The management terminal 101 acquires the SNMP response from the received SNMP packet, and ends the SNMP communication. The concrete operations will be described later using FIG. 15.

According to the information flow as described in the above [1] to [5], the management terminal 101 can transmit the SNMP request to the device to be managed 201, and receive the SNMP response from the device to be managed 201. In other words, the management of the device to be managed 201 performed over the NAT router 204 can be started from the management terminal 101.

Here, in the information flow in [4] and [5], that is, in the communication of the SNMP request and the SNMP response between the management center network 1 and the local network 2, the communication is performed using Hypertext Transfer Protocol Security (HTTPS) in the global network 3, thereby the communication security is guaranteed in the global network 3.

FIGS. 10 to 15 are sequence diagrams showing details of the information flow as shown in the above [1] to [5] and diagrams showing the configuration of communicated data. The operations performed by each device included in the communication network system 10 will be described in order as follows, using FIGS. 10 to 15.

FIG. 10 is a sequence diagram showing the operations performed by the device to be managed 201 and the communication relay client 202 when the communication relay client 202 acquires the device ID of the device to be managed 201. FIG. 10 corresponds with the information flow as described in [1] of FIG. 9. The operations performed by the communication relay client 202 will be described using FIG. 10, the communication relay client 202 associating the local network address of the device to be managed 201 with the device ID and storing the associated information into the local address table 2027.

After the device to be managed 201 and the communication relay client 202 are connected to the local network 2, the discovering packet transmission unit 2018 included in the device to be managed 201 transmits the communication relay client discovering packet for discovering the communication relay client 202 to multiple addresses (S101).

The discovering packet reception unit 2028 included in the communication relay client 202 receives the communication relay client discovering packet when the communication relay client 202 is connected to the same network as the device to be managed 201 (S102).

The discovering packet reception unit 2028 transmits a trigger to the device ID acquisition unit 2029, the trigger notifying that the communication relay client discovering packet has been received. After receiving the trigger, the device ID acquisition unit 2029 transmits the device ID acquisition request to the device to be managed (S103).

After receiving the device ID acquisition request (S104), the device ID distribution unit 2019 included in the device to be managed 201 transmits its own device ID to the communication relay client 202 (S105).

After receiving the device ID of the device to be managed 201 by the device ID acquisition unit 2029 (S106), the communication relay client 202 stores the association between the device ID of the device to be managed 201 and the local network address into the local address table 2027 (S107).

According to the steps as described above, the communication relay client 202 can derive the local network address of the device to be managed 201 based on the device ID by referring to the local address table 2027. In other words, in the case where the communication relay client 202 receives the SNMP request destined to the device ID of the device to be managed 201, the communication relay client 202 can transmit the SNMP request to the device to be managed 201.

FIG. 11 is a sequence diagram showing the operations performed by the communication relay client 202 in polling. FIG. 11 corresponds with the information flow as shown in [2] of FIG. 9. The operations of the communication relay client 202 will be described using FIG. 11, the communication relay client 202 polling to the trigger server 103.

The polling transmission unit 2025 included in the communication relay client 202 transmits a polling packet to the polling reception unit 1035 included in the trigger server 103 (S201). The polling packet is transmitted from the local network side to the global network side, thereby the communication is easily performed. The data unit of the polling packet includes one or more device IDs of the devices to be managed 201 connected to the local network 2.

Also, the transmission source address of the polling packet is rewritten to the global network address of the NAT router 204 by the NAT router 204 when the polling packet passes the NAT router 204.

After receiving the polling packet (S202), the polling reception unit 1035 associates the transmission source address of the received packet, that is the address of the NAT router 204, with the device ID of each device to be managed 201 included in the data unit, and stores the associated information (S203). In other words, in the case where two device IDs of the devices to be managed 201 are included in the data unit of the polling packet, the number of entries written into the global address table 1037 is also two.

Here, the polling transmission unit 2025 included in the communication relay client 202 transmits the polling packet in the form of the UDP packet. By transmitting the polling packet in the form of the UDP packet, the communication load can be reduced. Also, after transmitting the polling packet, the polling transmission unit 2025 retransmits the polling packet earlier than the expiration time when the associated information is deleted, the associated information being between the local network address of the communication relay client 202 and the global network address of the trigger server 103 stored in the address conversion table included in the NAT router 204.

Thus, the association between the local network address of the communication relay client 202 and the global network address of the trigger server 103 is always stored in the address conversion table included in the NAT router 204. In other words, in the case where the trigger packet destined to the communication relay client 202 connected to the local network 2 is transmitted at an arbitrary timing, the NAT router 204 can transfer the trigger packet to the communication relay client 202 based on the address conversion table.

The operations will be described as follows, the operations being performed by each device when the trigger packet transmitted from the trigger server 103 is transferred to the communication relay client 202 by the NAT router 204.

The trigger transmission unit 1036 included in the trigger server 103 transmits, to the trigger reception unit 2026 included in the communication relay client 202, the trigger packet in the form of the UDP packet as a response to the polling packet (S204). By transmitting the trigger packet in the form of the UDP packet, the communication load can be reduced.

The NAT router 204 receives the trigger packet (S205), and derives the local network address of the communication relay client 202 which is the transmission destination by referring to the address conversion table (S206). And, the NAT router 204 transfers the trigger packet to the derived local network address of the communication relay client 202 (S207).

As a result of the above mentioned operations, the trigger reception unit 2026 of the communication relay client 202 can receive the trigger packet from the trigger server 103 which is on the side of the global network 2 (S208).

As described above, the trigger packet is transmitted from the side of the global network 3 to the side of the local network 2. However, the trigger packet is transmitted as the response to the polling packet. Therefore, according to the steps S205, S206 and S207 as shown in FIG. 11, the NAT router 204 can transfer the trigger packet to the communication relay client 202. According to the above mentioned steps, the trigger server 103 can transmit the trigger packet to the communication relay client 202 at an arbitrary timing.

Here, the trigger packet is a packet which notifies the communication relay client 202 that the SNMP request exists in the communication relay server 102. After receiving the trigger packet, the communication relay client 202 can acquire the SNMP request from the communication relay server 102, and transmit the acquired SNMP request to the device to be managed 201. In other words, according to the trigger packet transmitted by the trigger server 103, the communication between the device connected to the global network 3 and the device connected to the local network 2 can be started at an arbitrary timing from the device connected to the global network 3.

FIG. 12 is a sequence diagram showing the operations of SNMP packet conversion performed by the communication relay server 102 and trigger packet transmission performed by the trigger server 103. And FIG. 12 corresponds with the information flow [3] as shown in FIG. 9. The operations performed by each device will be described using FIG. 12. The operations are performed from the time when the SNMP request is generated by the management terminal 101 until the time when the communication relay client 202 is notified of the SNMP request existence.

The operator performs a predetermined operation on the management terminal 101. And, the SNMP manager 4 included in the management terminal 101 generates an SNMP request indicating the request details for managing the device to be managed 201, and transmits the SNMP request in the form of an SNMP packet to the protocol conversion server 1022 included in the communication relay server 102 (S301).

Here, the transmission destination of the SNMP packet transmitted by the SNMP manager 4 is the communication relay server 102. However, the final transmission destination of the SNMP message included in the SNMP packet is the device to be managed 201. Thus, a method used by the communication relay server 102 for specifying the SNMP agent 5 will be described.

In order to specify the SNMP agent 5, the SNMP manager 4 must assign, to the communication relay server 102, information for specifying the device to be managed 201 which includes the SNMP agent 5. However, a field for the above mentioned information does not exist in the SNMP message per se as shown in FIG. 6. Thus, a device ID is attached and stored as the information for specifying the device in the community field included in the SNMP message.

Concretely, many of the SNMP managers assign community names in the form of character strings. The binary expression of the device ID is converted into a character string by BASE64 encoding. A character string is generated by attaching the BASE64 encoded device ID to the front of the original community name. Here, in the binary expression of the device ID, the byte sequence orders may be different between the transmission source and the transmission destination. Therefore, the byte sequence orders are standardized to a predetermined byte sequence order, and then the BASE64 encoding is performed.

In other words, the device ID is stored into the community field which exists in the frame format of the SNMP packet. Thereby, a general SNMP manager can manage devices using device IDs. Thus, no special function is required for the SNMP manager.

The protocol conversion server 1022 included in the communication relay server 102 receives, via the server side communication unit 1021, the SNMP request transmitted by the SNMP manager 4 (S302). Next, the protocol conversion server 1022 separates and acquires the device ID from the SNMP message included in the received SNMP packet, and performs processing such as rewriting the field length included in the SNMP message (S303).

The procedures of the above mentioned packet processing are performed as follows. First, the BASE64 encoded device ID and the original community name are separated. And, the BASE64 encoded device ID is converted back into the binary expression of the original device ID by the BASE64 decoding. The protocol conversion server 1022 acquires the device ID by the above mentioned processing. After that, the protocol conversion server 1022 rewrites the community field of the received SNMP message to the original community name, and deletes the part where the BASE64 encoded device ID is stored from the SNMP message.

Here, the community field length and the overall packet length have been changed. Thus, the respective fields for storing the community field length and the overall length of the SNMP message are rewritten to the correct values.

The protocol conversion server 1022 transmits the acquired device ID to the outside home communication server 1023 and the trigger request transmission unit 1024. And, the protocol conversion server 1022 transmits, to the outside home communication server 1023, using the communication between internal processings and the like, the SNMP message in which the device ID is deleted and the field length and the like are rewritten to the correct values. The outside home communication server 1023 queues the received SNMP message into the queuing area included in the outside home communication server 1023.

Next, the trigger request transmission unit 1024 included in the communication relay server 102 transmits a trigger request packet to the trigger request reception unit 1034 included in the trigger server 103 (S304). Here, the device ID of the device to be managed 201 and the global address of the communication relay server 102 are stored into the data unit of the trigger request packet.

After receiving the trigger request packet (S305), the trigger request reception unit 1034 searches the global address table 1037 for the device ID stored in the data unit of the trigger request packet, and derives the global network address of the NAT router 204 associated with the device ID. The trigger transmission unit 1036 included in the trigger server 103 transmits, to the derived global network address, the trigger packet including the global network address of the communication relay server 102 (S306).

The above mentioned trigger packet is transmitted over the NAT router 204 from the side of the global network 3 to the side of the local network 2. As described above, the NAT router 204 can derive the local network address of the communication relay client 202 by referring to the address conversion table. Thus, the NAT router 204 transfers the trigger packet to the communication relay client 202. And, the trigger reception unit 2026 included in the communication relay client 202 receives the trigger packet (S307).

As described above, the trigger packet includes the global network address of the communication relay server 102. The communication relay client 202 can specify the device where the SNMP request that should be acquired exists, based on the global network address, the communication relay client 202 having received the trigger packet according to the above mentioned steps.

FIG. 13 is a sequence diagram showing the operations of the converted packet acquisition and the SNMP request transmission performed by the communication relay client 202. FIG. 13 corresponds with the information flow [4] as shown in FIG. 9. The operations performed by each device will be described using FIG. 13. The operations are performed from the time when the communication relay client 202 receives the trigger packet until the time when the device to be managed 201 receives the SNMP request.

After the trigger reception unit 2026 included in the communication relay client 202 receives the trigger packet (S307), the outside home communication client 2023 included in the communication relay client 202 transmits a packet which requests to acquire the converted packet to the outside home communication server 1023 included in the communication relay server 102 (S308).

The packet which requests to acquire the converted packet is transmitted in the form of an HTTP request, using GET method. Also, HTTPS is used as the communication protocol, and falsification, spoofing and wiretapping are prevented.

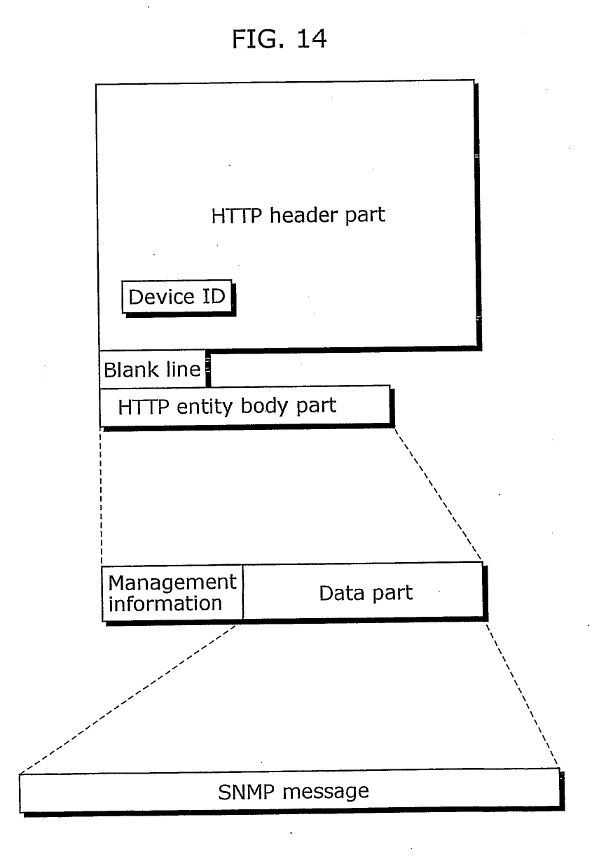

After receiving the packet which requests to acquire the converted packet (S309), the outside home communication server 1023 generates a converted packet as shown in FIG. 14. This converted packet includes in entity body: the SNMP message which has been received using the communication between internal processings and the like, and queued; and management information which includes communication times, success and failure of communication and the like. And, the converted packet is an HTTP response to which an HTTP header is added. The device ID of the device to be managed 201 is stored in the HTTP header part.

The outside home communication server 1023 transmits, to the communication relay client 202, the generated converted packet as a response to the packet which requests to acquire the converted packet, the packet being received from the communication relay client 202 (S310).

Here, the packet which requests to acquire the converted packet is transmitted from the communication relay client 202 to the communication relay server 102, that is, from the side of the local network 2 to the side of the global network 3 over the NAT router 204. Thereby, the communication is easily performed. The converted packet is transmitted from the communication relay server 102 to the communication relay client 202, that is, from the side of the global network 3 to the side of the local network 2 over the NAT router 204. However, since the converted packet is transmitted as the response to the packet which requests to acquire the converted packet, the communication is easily performed.

The outside home communication client 2023 included in the communication relay client 202 receives the converted packet as the HTTP response (S311). The outside home communication client 2023 transmits, to the protocol conversion client 2022, the SNMP message including request details and the device ID extracted from the HTTP header, using the communication between the internal processings and the like, the SNMP message being stored in the entity body part of the converted packet.

The protocol conversion client 2022 searches the local address table 2027 for the device ID, and derives the local network address of the device to be managed 201. The protocol conversion client 2022 adds a UDP header to the SNMP message, and generates an SNMP packet (S312), and then transmits the SNMP packet to the local network address of the device to be managed 201 (S313).

According to the above mentioned steps, the SNMP packet can be securely transmitted to the device to be managed 201, the SNMP packet being transmitted from the management terminal 101.

FIG. 15 is a sequence diagram showing operations in which the SNMP agent 5 included in the device to be managed 201 transmits, to the SNMP manager 4 included in the management terminal 101, the SNMP response which is the response to the SNMP request. FIG. 15 corresponds with the information flow [5] as shown in FIG. 9. The operations performed by each device will be described using FIG. 15, from the time when the device to be managed 201 receives the SNMP request to the time when the management terminal 101 receives the SNMP response.

After the device to be managed 201 receives the SNMP packet, the SNMP packet is transmitted to the SNMP agent 5 via the agent side communication unit 2011 (S314). After receiving the SNMP packet, the SNMP agent 5 performs the SNMP processing according to the request details included in the SNMP packet (S315). And, the SNMP agent 5 generates an SNMP response which is the result of the processing, and transmits the SNMP response to the protocol conversion client 2022 included in the communication relay client 202 (S316).

After receiving the SNMP packet from the device to be managed 201 (S317), the protocol conversion client 2022 transmits the SNMP message included in the received SNMP packet to the outside home communication client 2023 using the communication between the internal processings and the like.

The outside home communication client 2023 stores the received SNMP message into the entity body, and generates a converted packet as an HTTP packet using POST method (S318). And, then the outside home communication client 2023 transmits the converted packet to the outside home communication server 1023 included in the communication relay server 102 using HTTPS (S319). Here, the converted packet is transmitted from the side of the local network 2 to the side of the global network 3 over the NAT router 204, thereby the communication is easily performed.

After receiving the converted packet as the HTTP packet (S320), the outside home communication server 1023 extracts the SNMP message from the entity body, and transmits the SNMP message to the protocol conversion server 1022 using the communication between the internal processings and the like.

The protocol conversion server 1022 adds the UDP header to the received SNMP message, and generates the SNMP packet (S321). Moreover, using the same method as the SNMP manager 4 in transmitting the request packet to the communication relay server 102, the protocol conversion server 1022 attaches the BASE 64 encoded device ID to a community name, and stores the community name attached with the BASE 64 encoded device ID into the community field of the SNMP message, and then transmits the SNMP packet to the SNMP manager 4 (S322).

The SNMP manager 4 receives the SNMP packet (S323). In other words, the SNMP manager 4 receives the SNMP response corresponding to the transmitted SNMP request, and completes the SNMP communication.

As described above, in the communication network system 10 according to the embodiment of the present invention, the NAT router 204 uses the original function as it is. In other words, in order to perform communication as described in the embodiment of the present invention, the NAT router 204 needs not have a special gateway function, and no special setting operation needs to be performed on the NAT router 204.

Also, the communication relay client 202 transmits the polling packet to the trigger server 103, and notifies the global address of the local network 2 and the device ID of the device to be managed 201. Thereby, the start of the communication for managing the device to be managed 201 performed from the management terminal 101 can be notified to the communication relay client 202 using the trigger packet transmitted by the trigger server 103.

In addition, in the communication network system 10, the SNMP manager 4 exists as the client in the global network 3, and the SNMP agent 5 exists as the server in the local network 2.

In the above mentioned communication network, by performing a communication in which the client-server relation is interconverted using the NAT router 204 as a border, that is, by performing a communication accompanied by a protocol conversion between the communication relay server 102 set as the server in the global network 3 and the communication relay client 202 set as the client in the local network 2, the communication can be transparently performed from the SNMP manager 4 which is the client in the global network 3 to the SNMP agent 5 which is the server in the local network 2 over the NAT router 204.

In other words, the packet transmitted and received by the management terminal 101 and the device to be managed 201 is an SNMP packet, but the packet is communicated using the HTTPS in the global network 3. Thereby, without considering the communication path between the management terminal 101 and the device to be managed 201, the SNMP packet can be securely communicated.

As a result, the communication started from the management terminal 101 to the device to be managed 201 can be securely performed via the global network 3.

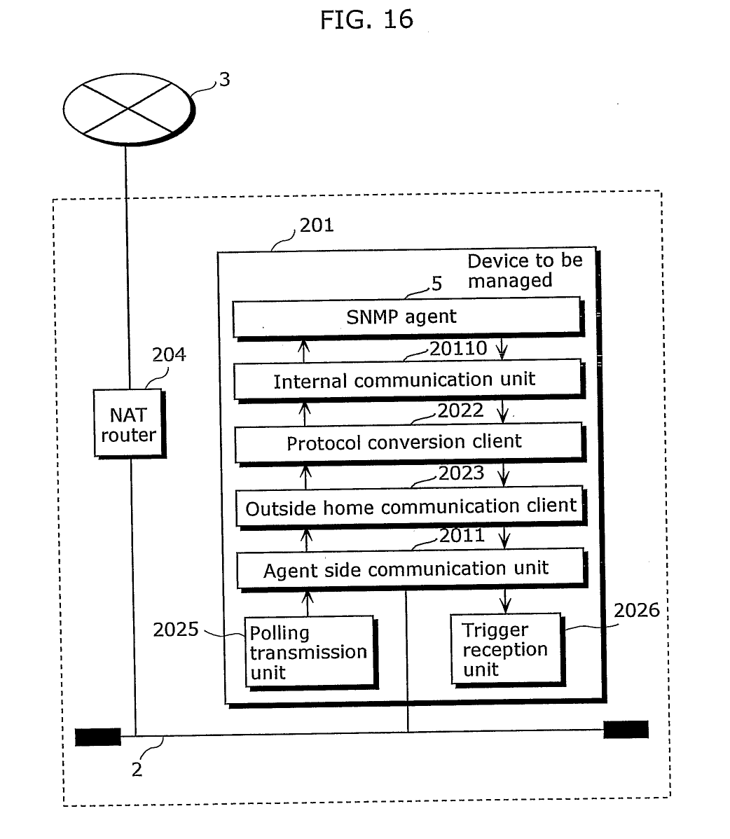

In the embodiment of the present invention, the communication relay client 202 and the device to be managed 201 are described as separate devices. However, there are other cases as well. For example, as shown in FIG. 16, the device to be managed 201 may include a function as the communication relay client 202.

In order to enable a communication between the SNMP agent 5 and the protocol conversion client 2022, the device to be managed 201 includes an internal communication unit 20110. As the internal communication unit 20110, for example, an interface whose communication is closed to the outside of the device such as a local loop-back interface is used. However, there are other possibilities. For example, the internal communication unit 20110 may be implemented in the agent side communication unit 2011, and the communication to the inside of the device may be performed as the internal communication unit 20110. In such case as described above, the protocol conversion client 2022 and the SNMP agent 5 can be associated one to one with each other. Thereby, the local address table 2027 is not necessary.

As described above, for example, in the case where a user uses a home electrical appliance including both a function of the device to be managed 201 and a function of the communication relay client 202, the user does not need to additionally prepare a communication relay client 202. And, the user can perform management and the like of the home electrical appliance via the global network from outside the home, only by connecting the home electrical appliance to the home local network.

Also, in the communication network system 10, in the case where the object with which the management terminal 101 communicates is limited to only the devices connected to the local network 2 and the like, the trigger server 103 is not necessary.

For example, the communication relay client 202 transmits a packet to the communication relay server 102 via the NAT router 204. The communication relay client 202 can store the global network address of the NAT router 204 according to the transmission source of the packet. Thus, in the case where the SNMP packet is transmitted from the management terminal 101, the SNMP packet is converted as described above. Then, the converted packet is transmitted to the address of the transmission source, and the converted packet is transmitted to the NAT, router 204. In such case as described above, the communication relay client 202 can receive the converted packet as a response to the packet transmitted from the communication relay client 202 to the communication relay server 102. The communication relay client 202 converts the received converted packet into the SNMP packet as described above, and transmits the SNMP packet to the device to be managed 201 based on the device ID included in the converted packet.

In addition, for example, the management terminal 101 may acquire the global network address of the NAT router 204 according to the packet transmitted from the communication relay client 202, and transmit the acquired global network address to the communication relay server 102. In other words, the communication network system 10 may be configured so that the devices connected to the management center network 1 can acquire the global network address of the NAT router 204, and the communication relay client 202 can receive the converted packet as the response to the transmitted packet.

As described above, the configuration of the management center network 1 can be simplified, and the hardware resource can be reduced.

Also, in the communication network system 10, as described using FIGS. 13 and 15, after receiving the trigger packet from the trigger server 103, the communication relay client 202 acquires one SNMP request from the communication relay server 102. After that, when the management terminal 101 receives the SNMP response which is the response to the SNMP request, the SNMP communication is ended.

In the above mentioned embodiment, after the communication relay client 202 receives the next trigger packet, the next SNMP request is processed. However, the communication relay client 202 may request the communication relay server 102 to acquire the SNMP request without waiting for the reception of the next trigger packet. In other words, the communication relay client 202 may sequentially transmit, to the communication relay server 102, the packet which requests to acquire converted packet.

In the communication performed using the SNMP which is a protocol used for managing the network devices, for example, in the case where the SNMP manager acquires a plurality of information from the SNMP agent, there is a case where a plurality of SNMP requests corresponding to the plurality of information are not transmitted at one time, but one SNMP request is transmitted, then, after the SNMP response corresponding to the SNMP request is received, the next SNMP request is transmitted. In other words, the plurality of SNMP requests are sequentially transmitted in order.

In order to deal with such sequential transmission of the SNMP requests, the above mentioned method used by the communication relay client 202 for sequentially transmitting the packet which requests to acquire the converted packet is useful. According to this method, the processing efficiency of each device included in the communication network system 10 can be improved, each device being involved in the management of the device to be managed 201. In such case as described above, in the case where the communication relay client 202 receives notification that the SNMP request does not exist, the transmission of the packet which requests to acquire the converted packet may be ended.

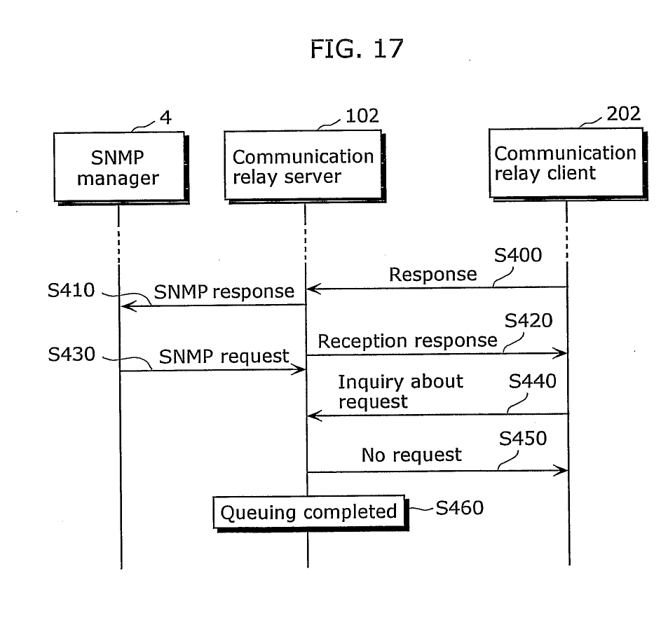

Also, in the case where the communication relay client 202 sequentially transmits the packets which request to acquire the converted packet, the communication relay server 102 may control the transmission timing. After receiving the SNMP packet from the SNMP manager 4 included in the management terminal 101, the communication relay server 102 performs processing on the SNMP message included in the SNMP packet such as deleting the device ID. The communication relay server 102 queues a processed SNMP message. As shown in FIG. 17, there is a case where a packet which requests to acquire the converted packet is transmitted from the communication relay client 202, the packet being the inquiry about the request, before queuing of the SNMP message is completed. In such case as described above, although the SNMP packet is received, the queuing of the SNMP message is not completed, thus a response indicating “no request” is transmitted to the communication relay client 202.

FIG. 17 is a sequence diagram showing the case where after returning a response to an SNMP request, the communication relay client 202 inquires about the next request to the communication relay server 102.

As shown in FIG. 17, the communication relay client 202 transmits a converted packet including the SNMP response to the communication relay server 102, (S400). The communication relay server 102 extracts an SNMP message which is an SNMP response from the received converted packet, and transmits the extracted SNMP message to the SNMP manager 4 included in the management terminal 101 (S410).

The communication relay client 202 receives a reception response as notification of having received the converted packet from the communication relay server 102 (S420).

After the communication relay server 102 receives the SNMP packet including the next SNMP request from the SNMP manager 4 (S430), the communication relay server 102 receives an inquiry about the next request from the communication relay client 202 (S440).

However, at this point, queuing of the SNMP message which is an SNMP request is not completed, and a response indicating “no request” is returned to the communication relay client 202 (S450).

In other words, from the time when the communication relay server 102 receives the SNMP packet (S430) until the time when the queuing of the SNMP message is completed (S460), in the case where the inquiry about the request (S440), that is, the packet which requests to acquire the converted packet, is transmitted from the communication relay client 202, since the queuing of the converted packet is not completed, the communication relay server 102 returns the response indicating “no request” to the communication relay client 202.

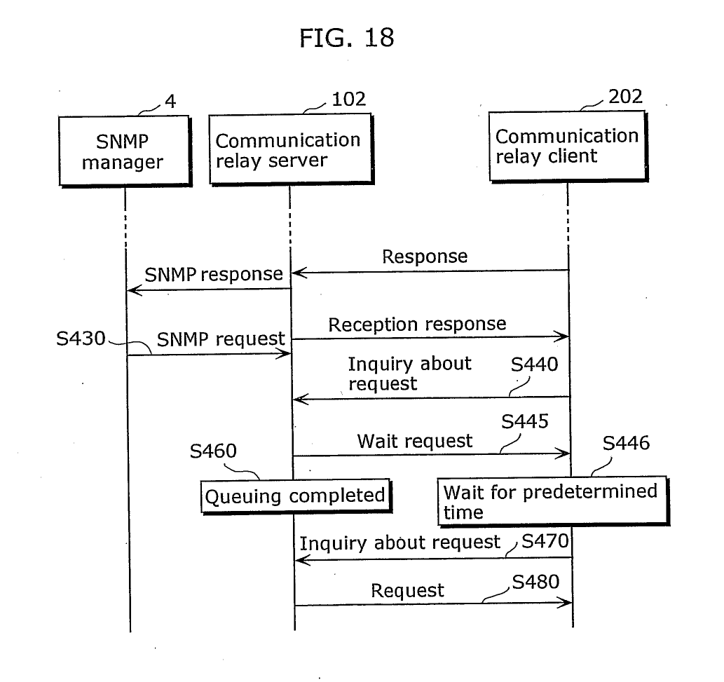

In such case as described above, the above mentioned method used by the communication relay server 102 is useful, the communication relay server 102 controlling the timing at which the communication relay client 202 transmits the packet which requests to acquire the converted packet. FIG. 18 is a sequence diagram showing an example of such control.

As shown in FIG. 18, after the communication relay server 102 receives the SNMP packet (S430), in the case where the communication relay client 202 inquires about the request, and the queuing of the SNMP message is not completed, the communication relay server 102 does not respond as “no request” to the communication relay client 202, but return “wait request” as the response, the “wait request” indicating a request to wait for acquiring the converted packet for a predetermined time (S445).

After receiving the “wait request”, the communication relay client 202 waits for a predetermined time (S446), and then inquires about the request (S470). At this point, the queuing is completed (S460), and the SNMP request can be acquired (S480).

The above predetermined time, that is the time when the communication relay client 202 waits for acquiring the converted packet, may be determined based on an actual measurement value and a logical value. Also, in the case where there is sufficient time when the packet is communicated between the communication relay server 102 and the communication relay client 202, the time for such waiting may be “0 seconds”. In other words, the optimum time for waiting may be determined for controlling the communication relay client 202.

In such case as described above, the number of wait request transmission is once. And, in the case where the communication relay server 102 receives the packet which requests to acquire the converted packet transmitted after the predetermined time in association with the wait request transmitted once, when the communication relay server 102 does not have a transmittable SNMP message, the communication relay server 102 responds as “no request”. Thus, the SNMP communication is ended.

Here, the condition for transmitting the wait request to the communication relay client 202 may not be the condition that the SNMP packet has been received but the queuing of the SNMP message is not completed, but may be the condition that the SNMP packet has not been received, or the processing on the SNMP message included in the SNMP packet is not completed, that is, the above mentioned condition that the communication relay server 102 does not have the SNMP message as information transmittable to the communication relay client 202.

Also, the wait request transmission may be determined according to the details of the SNMP request received just before by the communication relay server 102. For example, in the case where the details of the just received SNMP request are “GetNextRequest” or “GetBulkRequest” specified by the SNMP, even when the communication relay server 102 does not have an SNMP message transmittable to the communication relay client 202, the communication relay server 102 may predict that the SNMP packets would be sequentially transmitted from the SNMP manager 4, and may transmit the wait request in response to the inquiry about the request from the communication relay client 202.

In addition, instead of controlling the communication relay client 202 according to the waiting time, the communication relay client 202 may be controlled, for example, according to the number of wait request transmission. In other words, while the communication relay server 102 does not have an SNMP message transmittable to the communication relay client 202, the communication relay server 102 repeatedly transmits a wait request in response to the inquiry about the request from the communication relay client 202. After the number of wait request transmission repeated as described above has reached a specified number, in the case where the communication relay server 102 does not have a transmittable SNMP message when receiving the packet which requests to acquire the converted packet transmitted after a predetermined time in association with the just received wait request, the communication relay server 102 may respond as “no request”.

As described above, the communication relay server 102 controls the timing at which the communication relay client 202 transmits the packet which requests to acquire the converted packet. Thus, in the case where the SNMP packets including the SNMP requests are sequentially transmitted from the management terminal 101, the SNMP communication is not completed per processing on one SNMP request, but the processing can be efficiently performed on the SNMP requests.

Also, the SNMP communication is performed using UDP, and retransmission control is performed in the application layer. In the case where after transmitting the SNMP request to the communication relay server 102, the SNMP manager 4 does not receive an SMNP response associated with the SNMP request within a predetermined time, the SNMP manager 4 retransmits the SNMP message.

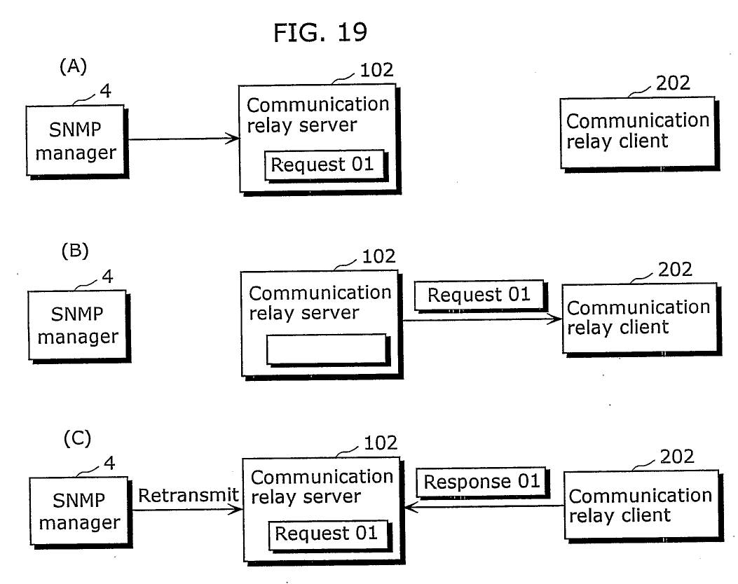

FIGS. 19A, 19B and 19C are diagrams showing respective communication patterns of SNMP requests and SNMP responses communicated between the SNMP manager 4, the communication relay server 102 and the communication relay client 202. When the SNMP packet is communicated between the respective devices, the SNMP packet including the SNMP message that is the SNMP request or the SNMP response, as described above, the packet conversion and the processing on the SNMP message are performed. However, in order to simplify the description, the illustrations and descriptions of such processings are omitted here.

As shown in FIG. 19A, “request 01” which is the SNMP request transmitted from the SNMP manager 4 is queued to the communication relay server 102. The queued “request 01” is transmitted to the communication relay client 202 as shown in FIG. 19B.

After transmitting the “request 01” to the device to be managed 201, the communication relay client 202 receives “response 01” which is the SNMP response associated with the “request 01”, and transmits the “response 01” to the communication relay server 102.

Here, the SNMP manager 4 and the communication relay server 102 operate asynchronously. Thereby, as shown in FIG. 19C, although the “response 01” which is the response associated with the “request 01” is transmitted from the communication relay client 202, since the SNMP manager 4 does not receive the “response 01” within a predetermined time after transmitting the “request 01”, the SNMP manager 4 retransmits the “request 01”. The communication relay server 102 requests the retransmitted “request 01”, and transmits the requeued “request 01” to the communication relay client 202. As a result, the SNMP manager 4 receives the “response 01” which is the response to the retransmitted “request 01”. However, the “response 01” is already received, thus abandoned.

As described above, in the case where although the SNMP agent 5 included in the device to be managed 201 transmits the SNMP response, the SNMP response does not reach the SNMP manager 4 within the predetermined time, the SNMP manager 4 retransmits the SNMP request indicating the details to request the SNMP response. Moreover, as the response to the retransmitted SNMP request, the SNMP response is retransmitted from the SNMP agent 5. In other words, the processed SNMP request and the SNMP response associated with the SNMP request are redundantly communicated.

Here, in the case where after the communication relay server 102 receives an SNMP request, the same SNMP request is transmitted, the later transmitted SNMP request may be abandoned. In such case as described above, the UDP communication is performed between the SNMP manager 4 and the communication relay server 102 in the same network, and the HTTPS communication is performed between the communication relay server 102 and the communication relay client 202. In other words, certainty of packet transmission can be highly maintained.

Thus, regardless of the type of the SNMP manager 4 or retransmission setting, redundant communication of packets can be prevented.

Also, according to the embodiment of the present invention, SNMP is used as the communication protocol for the client-server communication, that is, (i) the communication between the management terminal 101 and the communication relay sever 102 and (ii) the communication between the communication relay client 202 and the device to be managed 201. However, other protocols such as HTTP and TELNET may be used. For example, Simple Object Access Protocol (SOAP) may be used as a communication protocol standard for accessing the data stored in the remote machine, the SOAP using HTTP and the like as a lower protocol, and transmitting and receiving messages of a simple extensible Markup Language (XML) base.

Thus, according to the above mentioned embodiment, the communication network system is described as an example, the communication network system being used for remote-managing the devices. However, the communication network system 10 can be applied for other uses. For example, it is possible to start, from the devices connected to a global network, (i) operating a computer connected to a local network by a terminal connected to the global network and (ii) application cooperation between the devices connected to the global network and devices connected to the local network. In such case as described above, the communication relay server 102 and the communication relay client 202 may convert the communicated packets and the like.

Also, different IP addresses are assigned to the respective communication devices so that each device can be uniquely distinguished, the respective communication devices being connected to the global network 3 and the management center network 1. However, such addresses are not limited to the IP addresses, but, for example, Internetwork Packet exchange (IPX) addresses may be used as long as information is provided for identifying each device connected to the global network 3.

In addition, the trigger request packet stores the device ID of the device to be managed 201 in the data unit, the trigger request packet being transmitted from the communication relay server 102 to the trigger server 103. However, not only the device ID, but also other information may be stored in the data unit, as long as the information enables the trigger server 103 to identify the device to be managed 201. For example, an index value may be determined between the device to be managed 201 and the trigger server 103, the index value being linked to the device ID using a secure path such as HTTPS. And, the index value may be stored in the data unit of the trigger request packet, and then the trigger packet may be transmitted.

Thus, the number of device ID transmission is reduced in the management center network 1, and privacy protection of the device ID can be improved.

Also, the trigger packet includes the global network address of the communication relay server 102, the trigger packet being transmitted from the trigger server 103 to the communication relay client 202. However, other information than the global network address, such as URL, may be used as long as the information enables identifying the communication relay server 102 in the global network 3. Moreover, in the case where the device in which the SNMP request exists is always the communication relay server 102, address information needs not be included. Thus, capacity of the trigger packet can be reduced.

In addition, an index value may be previously linked to the global network address or Uniform Resource Locator (URL) of the communication relay server 102 using a secure path such as HTTPS between the communication relay server 102 and the communication relay client 202. And, the trigger packet may include the index value.

Thus, privacy protection of the global network address of the communication relay server 102 can be improved.

Also, the trigger packet may include the device ID of the device to be managed 201 which is the destination of the SNMP request. Thus, before acquiring the SNMP request, the communication relay client 202 can previously notify the device to be managed 201 that the SNMP request is coming. Thereby, the device to be managed 201 can prepare in advance.

In addition, the packet which requests to acquire a converted packet is transmitted in the HTTP request form, using the GET method. However, the POST method and the like may be used as well.

Moreover, HTTPS is used as the communication protocol when the packet which requests to acquire the converted packet and the converted packet are communicated between the communication relay client 202 and the communication relay server 102. However, other communication protocols such as HTTP and File Transfer Protocol (FTP) may be used, for example, in the case where privacy protection is assured for the packets communicated using an encryption means such as Pretty Good Privacy (PGP). In such case as described above, the packet which requests to acquire the converted packet may take the form associated with the communication protocol.

Thus, for example, it is possible to select a communication protocol by which a communication environment can be easily established. And, flexibility can be improved in hardware/software design when establishing the communication network system 10.

Also, in the communication network system according to the embodiment of the present invention, a sensor may be connected to the device to be managed 201, and the management terminal 101 may acquire information measured or detected by the sensor via the device to be managed 201.

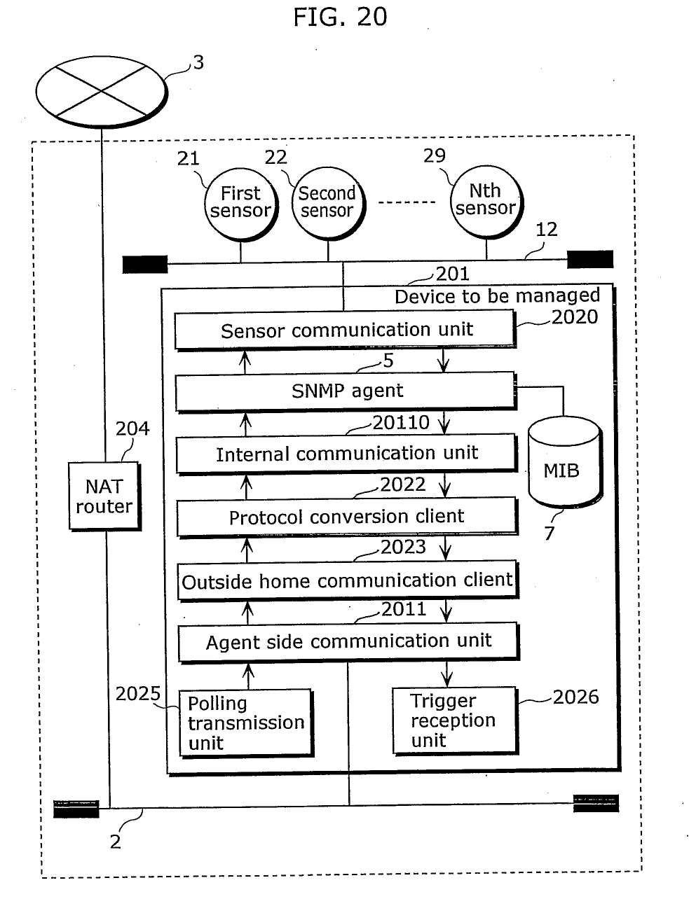

FIG. 20 is a functional block diagram showing an example of a functional configuration of a device to be managed 201 including a function of a communication relay client 202 and a function of communicating with a sensor.

As shown in FIG. 20, the device to be managed 201 has a configuration in which a sensor communication unit 2020 and a Management Information Base (MIB) 7 are added to the functional configuration of the device to be managed 201 as shown in FIG. 16.

The sensor communication unit 2020 is an example of a sensor information acquisition unit in the communication network system according to the present invention, and is a processing unit for communicating with one or more sensors. The sensor communication unit 2020 communicates with N (N is a positive integer) sensors which are the first sensor 21, the second sensor 22, . . . and the Nth sensor 29 that are respectively connected to a network 12. The communication protocol is, for example, an SNMP.

Here, in the device to be managed 201 as shown in FIG. 20, the protocol conversion client 2022 and the outside home communication client 2023 realize a transmission function held by a sensor information transmission unit included in the communication network system according to the present invention. Also, the SNMP agent 5 realizes a judgment function held by the judgment unit included in the communication network system according to the present invention.

The MIB 7 is an example of a storage unit included in the communication network system according to the present invention, and is a database which stores information related to the device to be managed 201 and information transmitted from each sensor. Information transmitted from the SNMP agent 5 to the SNMP manager 4 is acquired and transmitted by the MIB 7. Although the drawing of MIB is omitted in both FIG. 5 and FIG. 16, the respective devices to be managed 201 as shown in FIG. 5 and FIG. 16 include the MIB.

It is assumed that the device to be managed 201 is included in an air conditioner in home. In addition, it is assumed that the above mentioned N sensors are temperature sensors, and respectively set in each room of the home.

Each sensor transmits data (hereinafter, referred to as “sensor data”) to the sensor communication unit 2020, the data being a value of a measured temperature assigned with an identifier and the like.

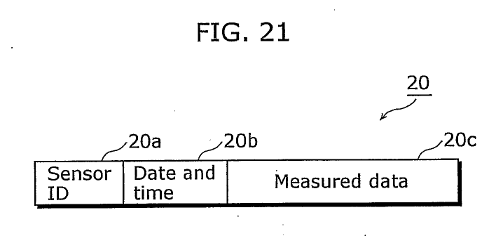

FIG. 21 is a diagram showing an example of a configuration of sensor data transmitted from a sensor. As shown in FIG. 21, sensor data 20 includes a sensor ID 20a, date and time 20b and measured data 20c.

The sensor ID 20a is an identifier for specifying a sensor. The date and time 20b is a time stamp of the sensor data 20. The time stamp indicates the date and time when a temperature is measured. The measured data 20c is data indicating a value of the measured temperature.

The sensor communication unit 2020 acquires sensor data from each sensor per predetermined cycle. The sensor communication unit 2020 causes the SNMP agent 5 to store the acquired sensor data 20 into the MIB 7. Thereby, the sensor data 20 stored in the MIB 7 is updated in a predetermined cycle.

The value of the temperature included in the sensor data 20 stored in the MIB 7 (hereinafter, referred to as “MIB value”) is transmitted to the SNMP manager 4 according to the request of the SNMP manager 4.

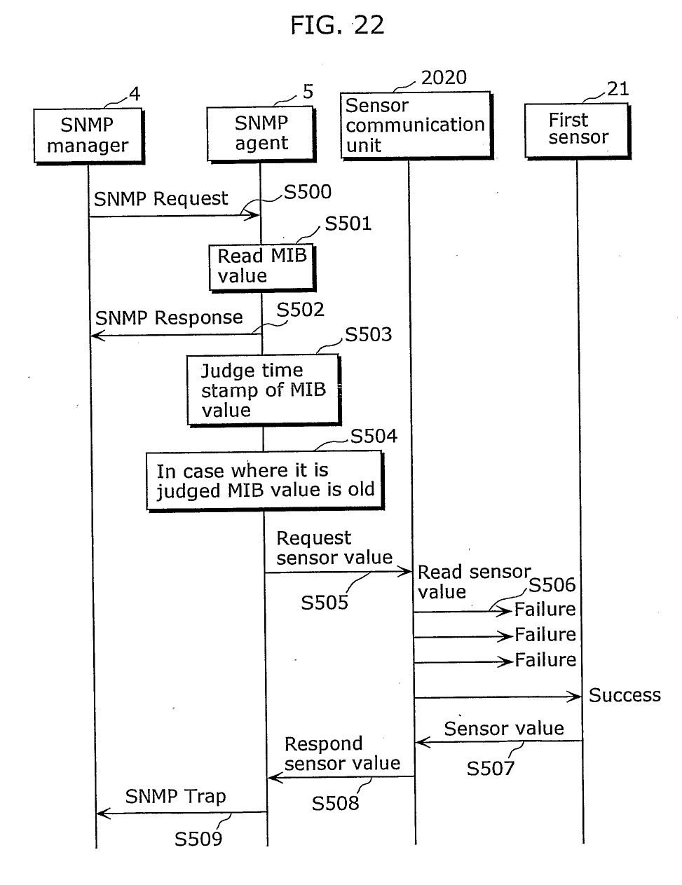

FIG. 22 is a sequence diagram showing operations performed by each device when the SNMP agent 5 transmits the value of the temperature measured by the first sensor 21 to the SNMP manager 4. The operations performed by each device will be described using FIG. 22. Here, in the MIB 7, the MIB value of the first sensor 21 already exists due to the above mentioned update.

In the communication between the SNMP agent 5 and the SNMP manager 4, as described above, the protocol conversion is performed by the outside home communication client 2023, the protocol conversion client 2022 and the communication relay server 102. However, the drawing and description of the protocol conversion are omitted here.

An SNMP request is transmitted from the SNMP manager 4 of the management terminal 101, the SNMP request indicating the details to request the value of the temperature measured by the first sensor 21 (S500).

The SNMP agent 5 of the device to be managed 201 receives the SNMP request, and reads the MIB value of the first sensor 21 (S501). The SNMP agent 5 transmits an SNMP response including the MIB value to the SNMP manager 4 (S502).

The SNMP agent 5 judges whether or not the MIB value is old based on the time stamp of the transmitted MIB value and a predetermined threshold (S503). The time stamp of the MIB value is the date and time 20b included in the sensor data 20 (refer to FIG. 21). The predetermined threshold is, for example, ten minutes. In the case where the difference between the date and time indicated by the time stamp and the current time is longer than ten minutes, it is judged that the MIB value is old. In the case where the difference between the date and time indicated by the time stamp and the current time is ten minutes or less, it is judged that the MIB value is new.

In the case where it is judged that the transmitted MIB value is new, the SNMP agent 5 ends the operation related to transmitting the value of the temperature.

In the case where it is judged that the transmitted MIB value is old (S504), the SNMP agent 5 requests the sensor communication unit 2020 to acquire the value of the temperature from the first sensor 21 (S505). The value of the temperature acquired from the first sensor 21 based on the request is called “sensor value” hereinafter.

After receiving the request from the SNMP agent 5, the sensor communication unit 2020 attempts to read the sensor value acquired from the first sensor 21 (S506).

Concretely, the sensor communication unit 2020 performs polling on each sensor connected to the network 12 in order to discover the first sensor 21. After succeeding in discovering the first sensor 21 by the polling, the sensor communication unit 2020 causes the first sensor 21 to transmit the sensor data 20 including the sensor value (S507).

The polling is performed at the maximum of five times until the first sensor 21 is discovered. In the case where the first sensor 21 can not be discovered after the five times of polling, the sensor communication unit 2020 notifies the SNMP agent 5 of the non-discovery. After receiving the notification, the SNMP agent 5 ends operations related to transmitting the value of the temperature.

After receiving the sensor data 20, the sensor communication unit 2020 transmits the sensor data 20 to the SNMP agent 5 (S508).

After receiving the sensor data 20, the SNMP agent 5 updates the sensor data 20 of the first sensor 21 which exists in the MIB 7. Moreover, the SNMP agent 5 extracts the sensor value from the sensor data 20, and notifies the SNMP manager 4 of the sensor value by SNMP trap (S509).

The SNMP trap means an SNMP message used when the SNMP agent spontaneously transmits information to the SNMP manager.

In the case where the time from the value of the temperature is first received from the device to be managed 201 (S502) until the value of the temperature is notified by the SNMP trap (S509) is within a predetermined period, the SNMP manager 4 recognizes that the value of the temperature notified by the SNMP trap is the correct value.

As described above, in the case where the value of the temperature measured by the sensor is requested from the SNMP manager 4, the SNMP agent 5 reads the value (MIB value) of the temperature measured by the sensor from the MIB 7, and transmits the MIB value to the SNMP manager 4. Thereby, the SNMP agent 5 can immediately respond to the request of the SNMP manager 4.

After transmitting the MIB value, the SNMP agent 5 judges whether or not the transmitted MIB value is old. In the case where it is judged that the MIB value is old, the SNMP agent 5 acquires the sensor value of the first sensor 21 via the sensor communication unit 2020. The SNMP agent 5 notifies the SNMP manager 4 of the sensor value by the SNMP trap.

Thereby, the SNMP agent 5 can notify the SNMP manager 4 of a more correct value of the temperature.

As described above, the communication network system and the communication apparatus according to the present invention can be used for a system for acquiring, from the management terminal 101, information measured or detected by the plurality of sensors connected to one device to be managed 201.

The operations performed by each device are described assuming that the N sensors are temperature sensors and the device to be managed 201 is included in an air conditioner. However, the sensor may not be a temperature sensor, and for example, may be other sensors such as a human sensor which detects human movement. Also, the device to be managed 201 may not be included in the air conditioner, and may be included in, for example, a home controller which manages a network-enabled device in home. Moreover, the device to be managed 201 may be used as a single unit.

The device to be managed 201 to which the sensor is connected may not include a function of the communication relay client 202. In such case as described above, the device to be managed 201 may be connected to the communication relay client 202, and the device to be managed 201 may communicate with the management terminal 101 via the communication relay client 202.

Also, the cycle per which the sensor communication unit 2020 acquires the sensor data 20 from each sensor may be determined by the user of the device to be managed 201 and set by the sensor communication unit 2020. Thereby, the cycle can be changed, for example, according to the state of the temperature change in the room where each sensor is set. In addition, the cycle may be set by the SNMP agent 5. In such case as described above, the SNMP agent 5 may direct the sensor communication unit 2020 to acquire sensor data.

When the sensor detects the temperature change, the sensor may notify the sensor communication unit 2020 of the value of the temperature at this time by the SNMP trap. Thereby, information stored in the MIB 7 can be always kept as updated information.

Also, the maximum number of polling for the sensor communication unit 2020 to discover a specific sensor may be less or more than five times. Instead of limiting the number of the polling, the period for which the polling is performed may be limited. For example, the polling may be ended in the case where the polling is repeatedly performed within three seconds and the specific sensor cannot be discovered. Thereby, the number or the period of the polling can be determined, for example, according to the importance of the value of the temperature measured by the sensor.

In addition, in the above embodiment, each sensor communicates with the sensor communication unit 2020 via the network 12. However, each sensor may wirelessly communicate with the sensor communication unit 2020.

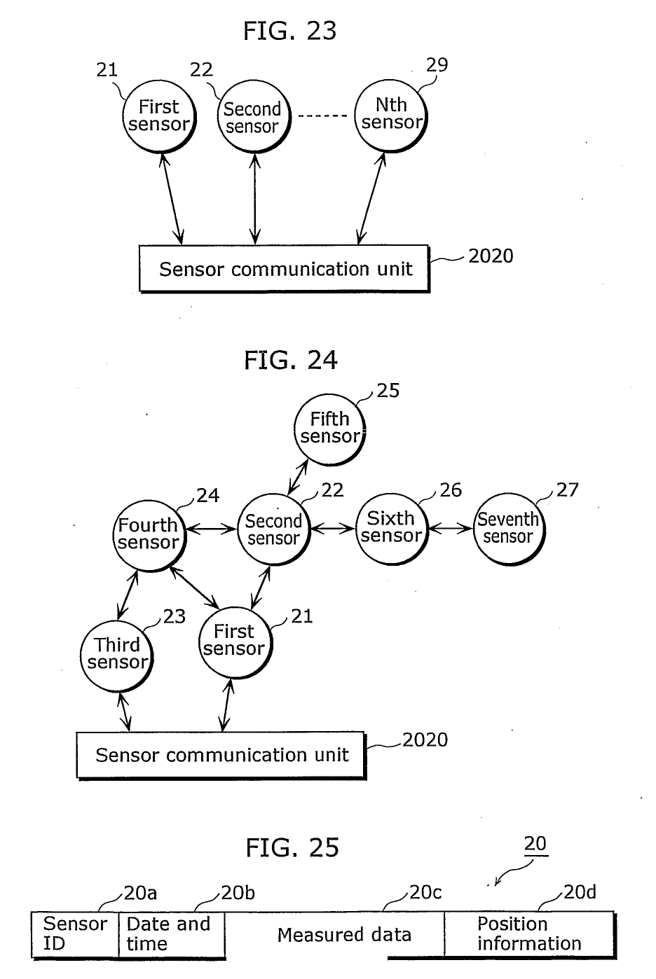

FIG. 23 is a schematic diagram showing the way that N sensors directly communicate with the sensor communication unit 2020 wirelessly. As shown in FIG. 23, since the sensor directly communicates with the sensor communication unit 2020 wirelessly, the sensor can be attached to a mobile object such as a human or an animal. In other words, information related to a mobile object can be acquired from the management terminal 101.

For example, by attaching, to a human, a step sensor which is a sensor for detecting foot steps, how many steps the human walked can be known from the management terminal 101.

Also, each sensor may communicate with the sensor communication unit 2020 via the ad-hoc network which is a network with that each sensor communicates.

FIG. 24 is a schematic diagram showing an ad-hoc network made up of a plurality of sensors. This ad-hoc network is made up of seven sensors which are the first sensor 21 to the seventh sensor 27. The sensor which is not close to the sensor communication unit 2020 can exchange information with the sensor communication unit 2020 using multi-hop communication.

For example, the sixth sensor 26 is far from the sensor communication unit 2020, and cannot directly communicate with the sensor communication unit 2020. However, the sixth sensor 26 can exchange information with the sensor communication unit 2020 via the second sensor 22 and the first sensor 21.

Thereby, each sensor can curb electric wave output for wireless communication. Thus, for example, duration of battery included as electric power in the sensor can be improved. Moreover, the sensor can be set in a place where the restriction on the electric wave is severe such as a hospital.

In the case where the sensor and the sensor communication unit 2020 wirelessly communicate with each other, the sensor may include the position information of the sensor in the sensor data 20.

FIG. 25 is a diagram showing an example of a configuration of the sensor data 20 including position information. Position information 20d is information indicating the position of the sensor when the sensor transmits the sensor data 20.

The sensor can roughly specify its own position, for example, depending on whether or not the sensor can communicate with the other fixed sensors. In the ad-hoc network as shown in FIG. 24, it is assumed that the first sensor 21 and the second sensor 22 are fixed in separate locations. In such case as described above, since the sixth sensor 26 communicates only with the second sensor 22, it can be recognized that the sixth sensor 26 is not close to the first sensor 21, but close to the second sensor 22.

Thus, when the sixth sensor 26 holds information regarding the location where the second sensor 22 is fixed, the sixth sensor 26 can roughly specify its own position. Moreover, the sixth sensor 26 can transmit, to the sensor communication unit 2020, information indicating its own position as position information 20d included in sensor data.

Thereby, for example, it can be known from the management terminal 101 whereabout the human attached with the step sensor is currently walking.

The method in which the sensor specifies its own position is not limited to the above mentioned method of specifying the self-position depending on the possibility of communication with the fixed sensor. For example, a position measurement apparatus may specify the position of a sensor, the position measurement apparatus being able to measure the position of the sensor optically or acoustically. And, the sensor may acquire information regarding its own position from the position measurement apparatus.

Also, the communication protocol used for the communication between the sensor communication unit 2020 and each sensor may not be SNMP. For example, ZigBee may be used.

In addition, instead of the sensor, an actuator may be connected to the device to be managed 201. And, the actuator may be controlled via the device to be managed 201 from the management terminal 101.

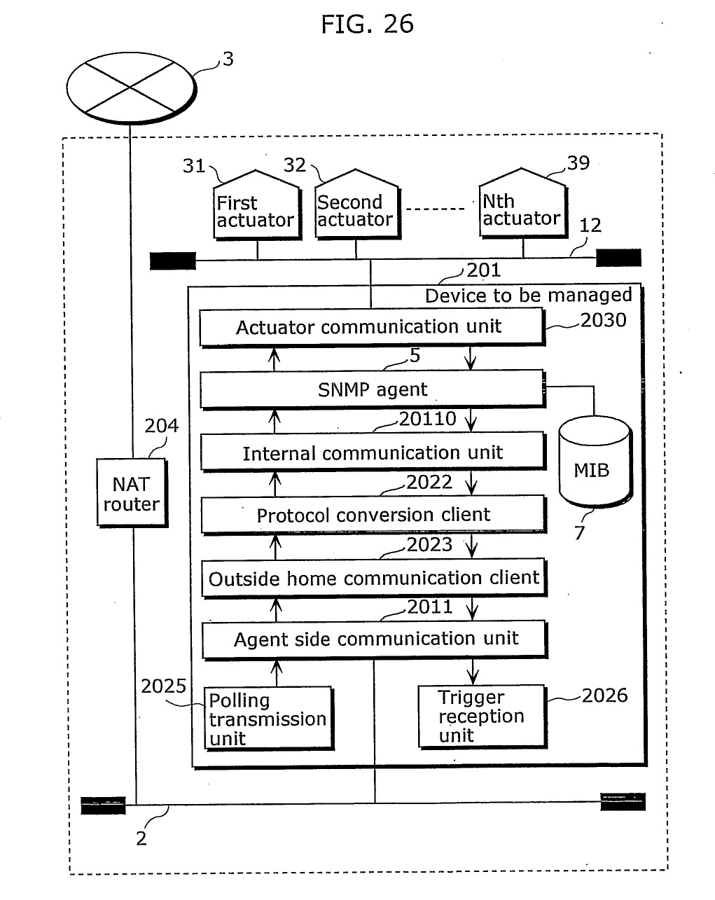

FIG. 26 is a functional block diagram showing an example of a functional configuration of a device to be managed 201 including a function of a communication relay client 202 and a function of communicating with an actuator.

As shown in FIG. 26, the device to be managed 201 includes an actuator communication unit 2030. The rest of the configuration is the same as the device to be managed 201 as shown in FIG. 20.

The actuator communication unit 2030 is a processing unit for communicating with the actuator. The actuator communication unit 2030 communicates with N actuators which are the first actuator 31, the second actuator 32, . . . and the Nth actuator 39 that are respectively connected to the network 12. The communication protocol is, for example, SNMP.

It is assumed that the device to be managed 201 is included in a home controller which manages a network-enabled device in home. Also, it is assumed that the N actuators are respectively an air conditioner, an electronic lock for locking a door and the like.

Each actuator holds a state value which is a value indicating its own state. For example, an air conditioner holds the value of the current preset temperature as the state value.

The actuator communication unit 2030 acquires the state value from each actuator per predetermined cycle. The actuator communication unit 2030 causes the SNMP agent 5 to store the acquired state value into the MIB 7. Thereby, the state value stored in the MIB 7 (hereinafter, referred to as “MIB value”) is updated in a predetermined cycle.

Here, the state value is transmitted from each actuator in a data form including an identifier of the transmission source and the like as well as the sensor data 20 as shown in FIG. 25.

Each actuator operates according to the request transmitted from the SNMP manager 4 of the management terminal 101. Also, each actuator notifies the device to be managed 201 of the state value after the operation.

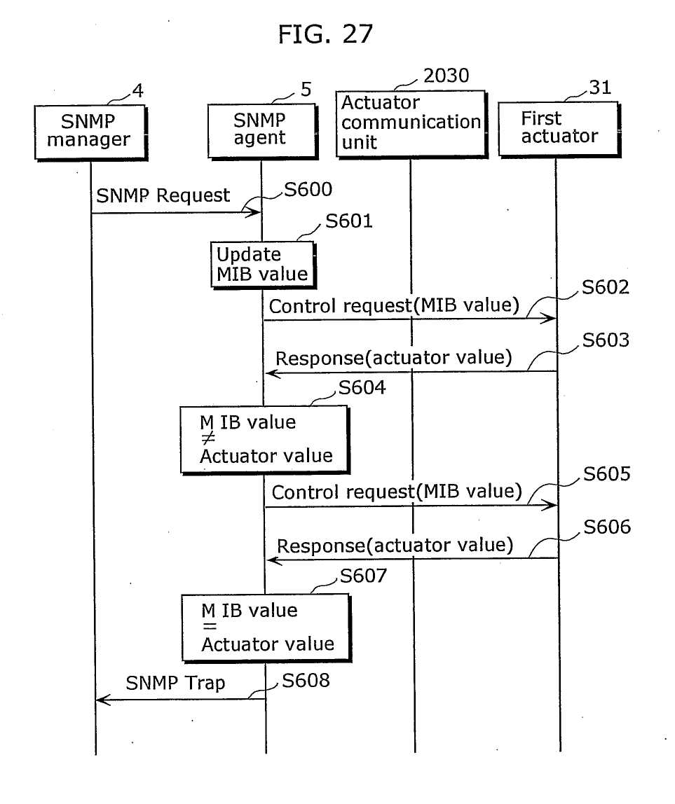

FIG. 27 is a sequence diagram showing operations performed by each device when the SNMP manager 4 requests the first actuator 31 to change a preset temperature.

The flow of the operations performed by each device will be described using FIG. 27.

Here, the following case is assumed: the first actuator 31 is an air conditioner, and the SNMP manager 4 of the management terminal 101 requests the first actuator 31 to change the preset temperature to “25° C.”.

An SNMP request is transmitted from the SNMP manager 4 of the management terminal 101, the SNMP request indicating a request to change the preset temperature of the first actuator 31 to “25° C.” (S600). Concretely, this SNMP request includes request details indicating a request to update the MIB value of the first actuator 31 to “25° C.”.

The SNMP agent 5 of the device to be managed 201 receives the SNMP request, and updates the MIB value to “25° C.” (S601).

After the update, the SNMP agent 5 requests the first actuator 31 to change the preset temperature to “25° C.” which is the updated MIB value (S602).

After receiving the above mentioned request, the first actuator 31 operates so as to change the preset temperature to “25° C.”. After the operation, the first actuator 31 transmits the state value (hereinafter, referred to as “actuator value”) of this time to the SNMP agent 5 (S603).

The SNMP agent 5 compares the transmitted MIB value with the received actuator value. For example, in the case where the actuator. value is “28° C.”, it does not correspond with the MIB value which is “25° C.” (S604). In other words, this means that the first actuator 31 has not operated as requested. Therefore, the SNMP agent 5 requests the first actuator 31 to change the preset temperature to “25° C.” again (S605).

After receiving the second request, the first actuator 31 operates so as to change the preset temperature to “25° C.”. After the operation, the first actuator 31 transmits the actuator value to the SNMP agent 5 (S606).

The SNMP agent 5 compares the transmitted MIB value with the received actuator value. For example, in the case where the actuator value is “25° C.”, it corresponds with the MIB value (S607). In other words, this means that the first actuator 31 has operated as requested. The SNMP agent 5 notifies the SNMP manager 4 of the MIB value by the SNMP trap (S608).

The request from the SNMP agent 5 to the first actuator 31 is repeatedly made at the maximum of five times until the MIB value transmitted by the SNMP agent 5 corresponds with the received actuator value.

As a result of the fifth request, in the case where the MIB value does not correspond with the actuator value, the SNMP agent 5 rewrites the MIB value of the first actuator 31 to the actuator value. The SNMP agent 5 further notifies the actuator value to the SNMP manager 4 by the SNMP trap.

As described above, the communication apparatus and communication network according to the present invention can be used for a system for controlling, from the management terminal 101, the plurality of actuators connected to one device to be managed 201. According to this system, for example, it is possible to control, from outside home, a plurality of home electrical appliances connected to one home controller.

Here, the air conditioner is an example of the actuator, and the actuator may be other devices or a mechanical section included in the device.

Also, the cycle per which the actuator communication unit 2030 acquires the state value from each actuator may be determined by the user of the device to be managed 201 and set in the actuator communication unit 2030. Thereby, for example, in the case where there are many actuators whose states are frequently changed, the user can set a short cycle. Also, the cycle may be set in the SNMP agent 5. In such case as described above, the SNMP agent 5 may direct the actuator communication unit 2030 to acquire the state value.

In the case where the actuator detects the change of its own state, the actuator may notify the actuator communication unit 2030 of the state value by the SNMP trap. Thereby, the updated information always exists in the MIB 7.

The request transmission from the SNMP agent 5 to the first actuator 31 may be less than five times or more than five times. Also, instead of the number of the request transmission, the request transmission may be limited by the period in which the request is transmitted. Thereby, the number or the period of the request transmission can be determined, for example, according to importance of operating the actuator.

Each actuator may wirelessly communicate with the actuator communication unit 2030.

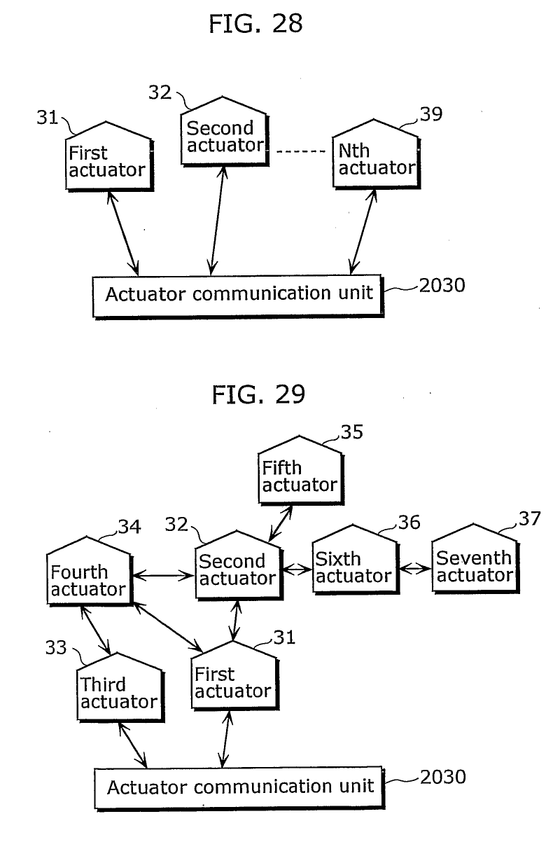

FIG. 28 is a schematic diagram showing the way that N actuators wirelessly communicate with the actuator communication unit 2030. As shown in FIG. 28, by directly communicating with the actuator communication unit 2030 wirelessly, the actuators become mobile. In other words, it is possible to control the mobile actuators from the management terminal 101.

In addition, each actuator may communicate with the actuator communication unit 2030 via the ad-hoc network which is a network with that each actuator communicates.

FIG. 29 is a schematic diagram of an ad-hoc network made up of a plurality of actuators. This ad-hoc network is made up of seven actuators which are the first actuator 31 to the seventh actuator 37. The second actuator 32 and the like can exchange information with the actuator communication unit 2030 using multi-hop communication, the second actuator 32 and the like not being able to directly communicate with the actuator communication unit 2030.

In such case as described above, as well as the case of the ad-hoc network made up of the plurality of sensors as shown in FIG. 24, each actuator can curb the electric wave output for wireless communication. Also, as well as the above mentioned sensor, each actuator may specify or acquire information regarding its own position, and may transmit the information to the actuator communication unit 2030.

Moreover, the communication protocol used for the communication between the actuator communication unit 2030 and each actuator may not be SNMP. For example, ZigBee may be used.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

A communication network system and a communication apparatus according to the present invention includes: a client on the global network side; and a server on the local network side. And, the communication network is useful for remote maintenance of home electrical appliances, remote control and the like. Also, the communication network system and the communication apparatus can be applied for browsing and operating contents stored in home electrical appliances and the like from outside the home.

1. A communication network system comprising a first system and a second system which are connected via a global network,
wherein said first system includes:
a terminal apparatus operable to communicate with a device; and
a first communication relay apparatus, which is connected to said terminal apparatus, operable to relay communication between said terminal apparatus and said second system via said global network,
said second system includes:
a router apparatus operable to connect said global network with a local network;
the device which is connected to said local network and is communicated with said terminal apparatus; and
a second communication relay apparatus operable to relay communication between said device and said first system via said router apparatus and said global network, said second communication relay apparatus being connected to said local network,
said first communication relay apparatus has:
a first communication unit operable to communicate with said terminal apparatus using a first protocol;
a second communication unit operable to communicate with said second system using a second protocol via said global network; and
a first conversion unit operable to convert packet data into second protocol packet data as a converted packet, the packet data being acquired from said terminal apparatus by said first communication unit, and to transmit the converted packet to said second communication unit, and also operable to convert packet data into first protocol packet data, the packet data being acquired from said second system by said second communication unit, and to transmit the first protocol packet data to said first communication unit,
said second communication relay apparatus has:
a third communication unit operable to communicate with the device using the first protocol via the local network;
a fourth communication unit operable to communicate with said first system using the second protocol; and
a second conversion unit operable to convert packet data into second protocol packet data, the packet data being acquired from the device by said third communication unit, and to transmit the second protocol packet data to said fourth communication unit, and also operable to convert the converted packet into first protocol packet data, the converted packet being acquired from said first system by said fourth communication unit, and to transmit the first protocol packet data to said third communication unit, and
said second communication relay apparatus is operable to transmit a predetermined packet to said first system via said router apparatus, and
said first system is operable to transmit the converted packet to an address of a transmission source of the predetermined packet.

2. The communication network system according to claim 1, further comprising
a trigger server operable to transmit a trigger packet to said second communication relay apparatus, the trigger packet causing said second communication relay apparatus to function as a client using the second protocol,
wherein said first system is operable to transmit the converted packet based on a request from said second communication relay apparatus responding to the trigger packet.

3. The communication network system according to claim 1,
wherein said second communication relay apparatus further has a device ID acquisition unit operable to acquire, from the device, a device ID for identifying the device, and to store the acquired device ID with an address of the device in the local network so that the device ID and the address are associated with each other, and
after receiving the converted packet, said second communication relay apparatus is operable to convert the received converted packet into first protocol packet data, based on the device ID included in the converted packet and the association stored in said device ID acquisition unit, and to transmit the first protocol packet data as a request packet to the device.

4. The communication network system according to claim 1,
wherein after receiving the packet data using the first protocol, the device is operable to transmit a response packet to said second communication relay apparatus using the first protocol, the response packet indicating the response,
after receiving the response packet, said second communication relay apparatus is operable to transmit the received response packet to said first communication relay apparatus using the second protocol, and
after receiving the response packet, said first communication relay apparatus is operable to convert the received response packet into first protocol packet data, and to transfer the first protocol packet data to said terminal apparatus.

5. The communication network system according to claim 2,
wherein said first communication relay apparatus is operable to transmit a trigger request packet to said trigger server, the trigger request packet providing a timing at which the trigger packet should be transmitted, and
after receiving the trigger request packet, said trigger server is operable to transmit the trigger packet.

6. The communication network system according to claim 5,
wherein said terminal apparatus is operable to transmit a request packet including request details for the device to said first communication relay apparatus using the first protocol, and
after receiving the request packet, said first communication relay apparatus is operable to transmit the trigger request packet to said trigger server.

7. The communication network system according to claim 2,
wherein said second communication relay apparatus is operable to transmit a polling packet to said trigger server, the polling packet enabling said trigger server to recognize existence of the transmission destination of the trigger packet, and to receive the trigger packet from said trigger server as a response to the polling packet.

8. The communication network system according to claim 7,
wherein the polling packet includes a device ID for identifying the device, and
after receiving the polling packet, said trigger server is operable to store the device ID included in the polling packet and the transmission source address of the polling packet so that the device ID and the address are associated with each other, and to identify, based on the device ID, the local network connected to the device having the device ID.

9. The communication network system according to claim 7,
wherein said router apparatus is operable to relay the polling packet from said second communication relay apparatus to said trigger server, to store the address of said second communication relay apparatus in the local network with the address of said trigger server in said global network so that the addresses are associated with each other, and to transfer a packet to said first communication relay apparatus according to the association in the case where the packet is received from said global network.

10. The communication network system according to claim 7,
wherein said second communication relay apparatus is operable to transmit the polling packet using User Datagram Protocol (UDP).

11. The communication network system according to claim 2,
wherein after receiving the trigger packet, said second communication relay apparatus is operable to transmit an acquisition request packet to said first communication relay apparatus, the acquisition request packet indicating a request to desire to acquire the converted packet,
after receiving the acquisition request packet, said first communication relay apparatus is operable to transmit the converted packet to said second communication relay apparatus, and
after receiving the converted packet, said second communication relay apparatus is operable to convert the received converted packet into first protocol packet data, and to transfer the first protocol packet data as a request packet to the device.

12. The communication network system according to claim 11,
wherein after receiving the trigger packet, said second communication relay apparatus is operable to repeatedly transmit one or more acquisition request packets to said second communication relay apparatus, each of the acquisition request packets indicating a request to desire to acquire the converted packet, until notification is received, the notification indicating that there is no information transmittable to said second communication relay apparatus, and
after receiving the acquisition request packet, (i) in the case where there is information transmittable to said second communication relay apparatus, the information being acquired from the packet data received from said terminal apparatus, said first communication relay apparatus is operable to transmit the converted packet including the information to said second communication relay apparatus, and (ii) in the case where there is no information transmittable to said second communication relay apparatus, said first communication relay apparatus is operable to notify said second communication relay apparatus that there is no information transmittable.

13. The communication network system according to claim 12,
wherein after receiving the acquisition request packet, in the case where there is no information transmittable, said first communication relay apparatus is operable to transmit a wait request to said second communication relay apparatus, the wait request being information indicating a request to transmit the acquisition request packet after a predetermined period elapses, and
in the case where said second communication relay apparatus receives the wait request, said second communication relay apparatus is operable to transmit the acquisition request packet to said first communication relay apparatus after the predetermined period elapses.

14. The communication network system according to claim 13,
wherein after receiving the acquisition request packet transmitted after the predetermined period elapsed, according to the wait request, in the case where there is no information transmittable, said first communication relay apparatus is operable to transmit the wait request, and
after a transmission number of the wait request reaches a predetermined number, in the case where said first communication relay apparatus receives the acquisition request packet transmitted after the predetermined period elapsed according to the wait request, and there is no information transmittable, said first communication relay apparatus notifies said second communication relay apparatus that there is no information transmittable.

15. The communication network system according to claim 2,
wherein said trigger server is operable to transmit the trigger packet using UDP.

16. The communication network system according to claim 1,
wherein said first protocol is Simple Network Management Protocol (SMNP).

17. The communication network system according to claim 16,
wherein said terminal apparatus is operable to transmit a request packet in the form of an SNMP packet to said first communication relay apparatus, the request packet including request details for the device,
when transmitting the request packet which is the SNMP packet, said terminal apparatus is operable to store data, into a predetermine field in the SNMP message included in the request packet, the data being a combination of the original field data and a device ID for identifying the device, and
after receiving the request packet, said first communication relay apparatus is operable to separate the device ID from the predetermined field of the SNMP field included in the request packet, thus to have only the original field data stored in the predetermined field, and to make respective lengths of the predetermined field and the SNMP message predetermined field lengths.

18. The communication network system according to claim 16,
wherein said first conversion unit is operable to acquire the SNMP message included in the packet data acquired from said second system by said second communication unit, to store data into the predetermined field of the SNMP message, the data being the combination of the original field data and the device ID for identifying the device data, and to transmit the SNMP message in the form of an SNMP packet to said terminal apparatus.

19. The communication network system according to claim 1,
wherein the second protocol is Hypertext Transfer Protocol (HTTP) or Hypertext Transfer Protocol Security (HTTPS).

20. The communication network system according to claim 1,
wherein the device includes the second communication relay apparatus.

21. The communication network system according to claim 1,
wherein said second system further includes a sensor connected to the device,
the device is operable to acquire sensor information measured or detected by said sensor, and also to transmit the acquired sensor information to said second communication relay apparatus using the first protocol,
after receiving the sensor information, said second communication relay apparatus is operable to transmit the received sensor information to said first communication relay apparatus using the second protocol, and
after receiving the sensor information, said first communication relay apparatus is operable to convert the received sensor information into first protocol packet data, and also to transfer the first protocol packet data to said terminal apparatus.

22. The communication network system according to claim 20,
wherein the device includes:
a sensor information acquisition unit operable to acquire the sensor information from said sensor;
a storage unit operable to store the sensor information;
a sensor information transmission unit operable to transmit the sensor information stored in said storage unit to said second communication relay apparatus using the first protocol; and
a judgment unit operable to judge whether or not a difference between a time when the sensor information is measured or detected by said sensor and a current time exceeds a predetermined threshold, after said sensor information transmission unit transmits the sensor information stored in said storage unit,
said sensor information acquisition unit is operable to acquire sensor information again from said sensor in the case where said judgment unit judges that the difference exceeds the predetermined threshold, and
said sensor information transmission unit is operable to transmit the sensor information acquired again by said sensor information acquisition unit to said second communication relay apparatus.

23. The communication network system according to claim 1,
wherein said second system further includes an actuator connected to the device,
the converted packet includes information for controlling said actuator,
after receiving the converted packet, said second communication relay apparatus is operable to convert the received converted packet into first protocol packet data, and also to transfer the first protocol packet data as a request packet to the device, and
the device is operable to transmit the information for controlling said actuator to said actuator, the information being included in the request packet.

24. A communication method for a terminal apparatus connected to a first system and a device connected to a second system in a communication network system,
wherein the system has a first system and a second system which are connected via a global network, and
said first system includes
a first communication relay apparatus operable to relay communication between said terminal apparatus and said second system via said global network, said first communication relay apparatus being connected to said terminal apparatus,
said second system includes:
a router apparatus operable to connect said global network with a local network; and
a second communication relay apparatus operable to relay communication between said device and said first system via said router apparatus and said global network, said second communication relay apparatus being connected to said local network,
said communication method comprising steps where:
said second communication relay apparatus is operable to transmit a predetermined packet to said first system via the router apparatus;
said first communication relay apparatus is operable to convert the packet into a second protocol packet as a converted packet, the packet being acquired from said terminal apparatus using the first protocol, and to transmit the converted packet to an address of the transmission source of the predetermined packet transmitted from said second communication relay apparatus; and
said second communication relay apparatus is operable to receive the converted packet transmitted from said first communication relay apparatus, to convert the received converted packet into first protocol packet data, and to transfer the converted packet data to the device.

25. A first communication relay apparatus which relays communication between a terminal apparatus and a second system via a global network, the first communication relay apparatus comprising:
a first communication unit operable to communicate with said terminal apparatus using a first protocol;
a second communication unit operable to communicate with said second system using a second protocol via said global network; and
a first conversion unit operable to convert packet data into second protocol packet data as a converted packet, the packet data being acquired from said terminal apparatus by said first communication unit, and to transmit the converted packet to said second communication unit, and operable to convert packet data into first protocol packet data, the packet data being acquired from said second system by said second communication unit, and to transmit the first protocol packet data to said first communication unit.

26. The first communication relay apparatus according to claim 22,
wherein in the case where said first communication unit receives packet data of the same details as the packet data after said first communication unit receives packet data from said terminal apparatus, said first communication unit is operable to abandon the later received packet data.

27. A program for relaying communication between a terminal apparatus and a second system via a global network, said program causing a computer to execute:
receiving first protocol packet data from said terminal apparatus;
converting the first protocol packet data received from said terminal apparatus into second protocol packet data;
transmitting the second protocol packet data to the second system via the global network;
receiving second protocol packet data from the second system;
converting the second protocol packet data received from the second system into first protocol packet data; and
transmitting the converted first protocol packet data to the terminal apparatus.

28. A second communication relay apparatus which is connected to a local network and relays communication between a device and a first system via a router apparatus and a global network, the second communication relay apparatus comprising:
a third communication unit operable to communicate with the device using a first protocol via the local network;
a fourth communication unit operable to communicate with said first system using a second protocol; and
a second conversion unit operable to convert packet data into second protocol packet data, the packet data being acquired from the device by said third communication unit, and to transmit the second protocol packet data to said fourth communication unit, and operable to convert a converted packet into first protocol packet data, the converted packet being converted into second protocol packet data and acquired from said first system by said fourth communication unit, and to transmit the first protocol packet data to said third communication unit,
said fourth communication unit is operable to transmit a predetermined packet to said first system via the router apparatus, and to receive the converted packet transmitted from the first system to an address of the transmission source of the predetermined packet.

29. A program for relaying communication between a device and a first system via a router apparatus and a global network, the program comprising:
notifying the first system of a predetermined packet via the router apparatus;
receiving second protocol packet data transmitted from the first system to an address of the transmission source of the predetermined packet;
converting the second protocol packet data received from the first system into first protocol packet data;
transmitting the first protocol packet data to the device via a local network;
receiving first protocol packet data from the device via the local network;
converting the first protocol packet data into second protocol packet data, the first protocol packet data being received from the device; and
transmitting the second protocol packet data to the first system.
